(19) United States
(12) Patent Application Publication
(10) Pub. No.: US 2021/0019839 A1
(43) Pub. Date: Jan. 21, 2021

(54) PROVIDING PEER-TO-PEER RECOMMENDATIONS WITHIN A SOCIAL NETWORKING SYSTEM

(71) Applicant: Facebook, Inc., Menlo Park, CA (US)

(72) Inventors: Zhouyue Su, San Francisco, CA (US); Katrina Li, New York, NY (US); Luyi Guo, Sunnyvale, CA (US); Ashlee Aiesha Edwards Brinegar, Palo Alto, CA (US); Nicholas John Konstantaras, San Francisco, CA (US); Johan Lindell, East Palo Alto, CA (US); Alec Hubel, San Francisco, CA (US); Yang Pei, Mountain View, CA (US); Arpit Jain, Sunnyvale, CA (US); Guang Yao Leng, Mountain View, CA (US); Tyler Gross, San Francisco, CA (US)

(21) Appl. No.: 16/516,673

(22) Filed: Jul. 19, 2019

(51) Int. Cl. G06Q 50/00; G06F 16/9535

(52) U.S. Cl. CPC G06Q 50/01; G06F 16/9535

(57) ABSTRACT

The present disclosure relates to systems, methods, and non-transitory computer readable media that implement a peer-to-peer social media recommendation system. For example, the peer-to-peer recommendation process can involve providing social media accounts to a recommender to recommend to a recommendee. For example, based on determining triggering criteria, the disclosed systems can determine social media accounts for a recommender to recommend to a recommendee based on recommender features and recommendee features. In addition, the disclosed systems can provide a recommender user interface for display on a recommender device that includes a listing of social media accounts together with selectable options to recommend the social media accounts to a recommendee. The disclosed systems can further provide a recommendee user interface to a recommendee device to display social media accounts recommended by the recommender together with selectable options to follow the social media accounts.

### BACKGROUND

Advancements in software and hardware platforms have led to a variety of improvements in systems that connect users within a social network. For example, digital communication systems are now able to determine similarities between users based on user information such as interests, geographic location, and job title (among others). Some systems can suggest contacts for users based on similarities or other factors.

Despite these advances however, conventional digital communication systems continue to suffer from a number of disadvantages, particularly in their accuracy, efficiency, and flexibility. For example, to provide a suggestion of a second user for a first user to add to a contact list, conventional systems often analyze information associated only with the first user and the second user without considering any additional information. Due at least in part to the limited nature of the information analyzed by conventional systems, many of these conventional systems often inaccurately suggest contacts to users. The inaccuracies of recommendations are often exacerbated when recommending contacts to new users. Indeed, for a user that has recently registered, conventional systems often generate suggested contacts that are inaccurate due to the limited amount of information the system has obtained for the user within the short time since registering.

As another disadvantage, conventional digital communication systems are inefficient. In particular, many conventional systems inefficiently utilize computer resources such as computing time and computing power. To elaborate, many conventional systems utilize excessive computing time and computing power to generate large amounts of spam communications between users. In addition, conventional systems provide user interfaces that inefficiently require users to navigate through many layers and perform excessive number of user actions to drill down to desired data and/or functionality. For example, many conventional systems provide notifications of suggested contacts within a user interface that requires a user to navigate away from a currently viewed interface to view and/or manage the contact suggestion within a separate window (or a separate application). As a further result of generating and providing inefficient user interfaces, many of these conventional systems waste computation power and computation time in processing the excessive user interactions required for navigating through the user interfaces to view and/or manage the contact suggestions.

Many conventional digital communication systems are also inflexible. To illustrate, many conventional systems utilize a fixed contact suggestion process that includes analyzing information for a given user and analyzing information for other users to determine which of the other users to suggest to the given user as a contact. By utilizing such a fixed contact suggestion process, these conventional systems cannot adapt to utilize different means (and different information). Further, many conventional systems rigidly apply a uniform method of providing contact suggestion notifications to a user. For example, some conventional systems provide notifications of suggested contacts exclusively using a particular format or delivery method.

Further, conventional digital communication systems are often confusing or difficult for users to navigate. For example, new users of conventional systems are frequently overwhelmed with the number of options available to them for connecting with other users that users often find it difficult to know who to follow or how to follow them. Indeed, many conventional systems rely too heavily on a user's knowledge of the system to effectively connect with friends and acquaintances. As a result, many conventional systems have a relatively low likelihood of connecting people together who would otherwise enjoy such interaction in the digital sphere.

### SUMMARY

One or more embodiments described herein provide benefits and solve one or more of the foregoing or other problems in the art with systems, methods, and non-transitory computer readable media that determine, by utilizing a recommendation engine, social media accounts to provide to a recommender device for a recommender to recommend to a recommendee. More specifically, the disclosed systems can analyze information associated with a recommender as well as information associated with a recommendee to accurately identify social media accounts to provide to the recommender to recommend to the recommendee. Indeed, the disclosed systems can determine triggering criteria associated with the recommender and/or the recommendee for providing a ranked list of social media accounts from which the recommender can select to recommend to the recommendee. In addition, the disclosed systems can dynamically provide a recommender user interface that enables a recommender to select one or more social media accounts to recommend to the recommendee. The disclosed systems can further provide an efficient recommendee user interface that enables a recommendee to view and manage social media account recommendations with relatively few user interactions.

Additional features and advantages of the present application will be set forth in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment for implementing a peer-to-peer recommendation system in accordance with one or more embodiments;

FIGS. 2A-2B illustrate sequence diagram of acts in an example process of performing peer-to-peer recommendations in accordance with one or more embodiments;

FIG. 3 illustrates an example user interface on a recommender device for selecting an option to recommend social media accounts to a recommendee in accordance with one or more embodiments;

FIG. 4 illustrates an example recommender user interface in accordance with one or more embodiments;

FIG. 5 illustrates an example interface of an activity feed including a notification of a recommended social media accounts in accordance with one or more embodiments;

FIG. 6 illustrates an example recommendee user interface in accordance with one or more embodiments;

FIG. 7 illustrates an example flow of utilizing a recommendation engine to determine social media accounts to provide to a recommender device in accordance with one or more embodiments;

FIG. 8 illustrates a schematic diagram of a peer-to-peer recommendation system in accordance with one or more embodiments;

FIG. 9 illustrates a flowchart of a series of acts for generating and providing social media accounts for a recommender profile to recommend to a recommendee profile in accordance with one or more embodiments;

FIG. 10 illustrates a block diagram of an example computing device in accordance with one or more embodiments;

FIG. 11 illustrates an example network environment of a networking system in accordance with one or more embodiments; and

FIG. 12 illustrates a social graph in accordance with one or more embodiments.

### DETAILED DESCRIPTION

One or more embodiments described herein provide benefits and solve one or more of the foregoing or other problems in the art with peer-to-peer recommendation system that determines, by utilizing a recommendation engine, social media accounts to provide to a recommender device for a recommender to recommend to a recommendee. In particular, the peer-to-peer recommendation system can detect that a new user (i.e., the recommendee) has joined a social networking system and that the recommendee follows a recommender account or a recommender profile. Based on receiving the indication to follow the recommender profile, the peer-to-peer recommendation system can generate a recommender user interface whereby the recommender can recommend social media accounts for the recommendee to follow. In addition, the peer-to-peer recommendation system can populate the recommender user interface to include a ranked list of social media accounts to recommend to the recommendee. To generate the ranked list, the peer-to-peer recommendation system can utilize a recommendation engine to analyze features associated with the recommender (e.g., the recommender profile, recommender activity on the social media network, social media accounts connected with the recommender), features associated with potential recommended social media accounts, and/or features associated with the recommendee (e.g., the recommendee profile, recommendee activity on the social media network, social media accounts connected with the recommendee) to identify and rank social media accounts to recommend to the recommendee. The peer-to-peer recommendation system can further receive a selection from the recommender of a social media account to recommend to the recommendee.

As mentioned, the peer-to-peer recommendation system can enable a recommender associated with a recommender account to suggest or recommend other social media accounts to a recommendee, whereupon the recommendee can opt to follow one or more of the recommended social media accounts. To determine social media accounts to provide to the recommender for recommending to the recommendee, the peer-to-peer recommendation system can determine one or more triggering criteria to trigger (e.g., as a prerequisite for) utilizing a recommendation engine to determine or identify a plurality of social media accounts for the recommender profile to recommend and/or for prompting the recommender to recommend social media accounts. Indeed, the peer-to-peer recommendation system can utilize triggering criteria to prevent recommenders from spamming recommendees with excessive recommendations.

To elaborate, the peer-to-peer recommendation system can determine triggering criteria based on recommender profile information. In some embodiments, for instance, the peer-to-peer recommendation system determines triggering criteria by determining that the recommender profile has been active for a threshold number of days over a particular duration of time. The peer-to-peer recommendation system can further determine triggering criteria by determining that the recommender visits the recommendee profile and/or by determining that the recommender follows the recommendee profile after the recommendee has followed the recommender profile. Further, the peer-to-peer recommendation system can require (e.g., as part of the triggering criteria) that a threshold period of time expires before determining or providing social media accounts for the recommender to recommend.

Additionally (or alternatively), the peer-to-peer recommendation system can determine triggering criteria based on recommendee profile information. For example, the peer-to-peer recommendation system can determine that the recommendee profile has followed the recommender profile. In addition, the peer-to-peer recommendation system can determine that the recommendee profile is a new profile (e.g., for a newly registered account) within a threshold recency and/or that has followed fewer than a threshold number of other social media accounts. In some embodiments, the peer-to-peer recommendation system utilizes multiple triggering criteria together using any of a number of possible combinations of triggering criteria as a prerequisite for providing social media accounts to the recommender for the recommender to recommend to the recommendee.

As mentioned above, to generate or determine social media accounts for the recommender profile to recommend to the recommendee profile, the peer-to-peer recommendation system can utilize a recommendation engine. In particular, the peer-to-peer recommendation system can utilize a recommendation engine to analyze recommender features as well as recommendee features to determine, from a database of social media accounts associated with a social networking system, a plurality of social media accounts for the recommender to recommend to the recommendee. In some embodiments, the peer-to-peer recommendation system can utilize a recommendation engine in the form of one or more machine learning models and/or algorithms. For instance, the recommendation engine can analyze various features such as social media accounts that the recommender follows, social media accounts that the recommendee follows, user profiles and demographic information of the recommender and/or recommendee, social media accounts that the recommender and/or recommendee interacts with, and/or probabilities of liking different topics of interest, among others.

Based on analyzing the features, the recommendation engine can generate a listing of a plurality of social media accounts for the recommender to recommend to the recommendee. Indeed, the recommendation engine can generate a listing of social media accounts that is specific to the particular recommender-recommendee combination. In some embodiments, the peer-to-peer recommendation system utilizes the recommendation engine to generate a ranked list of the plurality of social media accounts, where the social media accounts are ranked based on assigned scores that indicate, for example, a probability or likelihood that the recommendee will follow the respective social media account.

As mentioned, the peer-to-peer recommendation system can generate and provide user interface elements for display via a recommender user interface. In particular, the peer-to-peer recommendation system can provide a listing of the plurality of social media accounts for recommending to the recommendee for display within a recommender user interface presented on a recommender device. In some embodiments, upon generating the plurality of users and determining that the triggering criteria are satisfied, the peer-to-peer recommendation system provides a prompt, such as a push notification, for display on the recommender device including selectable options to recommend the various determined social media accounts. In the same or other embodiments, the peer-to-peer recommendation system enables the recommender to search for social media accounts to recommend via a search option within the recommender user interface.

As also mentioned, the peer-to-peer recommendation system can generate and provide user interface elements for display via a recommendee user interface. In particular, the peer-to-peer recommendation system can, in response to receiving or detecting an indication or selection of an option to recommend a social media account from a recommender device, provide a notification for display within a recommendee user interface presented on a recommendee device. For example, the peer-to-peer recommendation system can provide a notification for display within an activity feed of the recommendee profile. The peer-to-peer recommendation system can further detect or receive an indication or selection of the notification (e.g., within the activity feed). Based on the selection of the notification, the peer-to-peer recommendation system can further provide, for display within the recommendee user interface presented on the recommendee device, a display of the selected social media account together with an option to follow the social media account. In some embodiments, the peer-to-peer recommendation system provides a listing of any selected social media accounts that the recommender has recommended to the recommendee (the recommender can select multiple social media accounts to recommend) based on the selection of the notification.

The peer-to-peer recommendation system provides several advantages over conventional digital communication systems. For example, the peer-to-peer recommendation system improves accuracy relative to conventional systems. More specifically, the peer-to-peer recommendation system analyzes signals or features from both the recommender profile and the recommendee profile, which improves the accuracy of determining social media accounts that a recommendee is likely to follow, as compared to conventional systems which ordinarily utilize information from only the recommendee. Particularly, the peer-to-peer recommendation system improves accuracy in generating social media accounts for recommending to a recommendee that is a new user of a social networking system. Indeed, whereas conventional systems often inaccurately determine recommended social media accounts for new social media accounts (due to the limited amount of information available in the short time since the new user has registered), the peer-to-peer recommendation system utilizes a more robust source of information by further analyzing features associated with the recommender profile to generate accurate recommended social media accounts even for new social media accounts.

Along these lines, the peer-to-peer recommendation system has higher likelihood than conventional systems of connecting users to together in a social networking environment due its utilization of recommender and recommendee features. Indeed, whereas conventional systems often rely on a user's understanding of how to navigate through various interfaces to connect with desired accounts, the peer-to-peer recommendation system intelligently provides suggestions of connections to recommend based on information associated with social media accounts such a recommender profile and a recommendee profile. The peer-to-peer recommendation system yet further improves the likelihood of connecting social media accounts by providing such recommendations to recommender profiles. Thus, as opposed to recommendations that are entirely system-provided, as with some conventional systems, the recommender profiles can recommend social media accounts for recommendee profiles to follow in a more personalized, peer-to-peer manner.

In addition, the peer-to-peer recommendation system improves efficiency over conventional systems. For example, in contrast to conventional systems that waste computer resources by generating large amounts of spam communications, the peer-to-peer recommendation system prevents recommenders from spamming recommendees by utilizing triggering criteria. Indeed, the peer-to-peer recommendation system determines that triggering criteria are satisfied before enabling or prompting a recommender to recommend social media accounts to a recommendee. Thus, by not generating and distributing excessive spam communications across connected devices over a network, the peer-to-peer recommendation system utilizes less processing power and less processing time than conventional systems.

Additionally, the peer-to-peer recommendation system provides recommender user interfaces and recommendee user interfaces that are more efficient than user interfaces of conventional systems. For example, upon determining that triggering criteria are satisfied, the peer-to-peer recommendation system automatically populates a recommender user interface with a ranked list of social media accounts to recommend to the recommendee, together with selectable options to recommend the respective profiles. Thus, unlike conventional systems that provide no means whereby a recommender can recommend social media accounts for a recommendee to follow, the peer-to-peer recommendation system provides user interface elements that enable a recommender to provide recommendations with few user interactions and little navigation.

Additionally, from the perspective of the recommendee, the peer-to-peer recommendation system provides a recommendee user interface that is more efficient than user interfaces of conventional systems. For instance, unlike conventional systems that require users to navigate through multiple interfaces (or applications) to view or manage recommendations, the peer-to-peer recommendation system provides selectable notifications of recommended social media accounts and further provides selectable options to follow social media accounts with fewer user interactions and less navigation.

As a further advantage, the peer-to-peer recommendation system improves flexibility over conventional digital communication systems. Particularly, as opposed to conventional systems that rigidly utilize a single process for generating recommendations (which are not provided by a recommender), the peer-to-peer recommendation system flexibly allows a recommender to utilize multiple techniques for providing recommended social media accounts to a recommendee. Indeed, the peer-to-peer recommendation system can automatically generate social media accounts to provide to a recommender for recommending to a recommendee, and the peer-to-peer recommendation system can also (or alternatively) enable a recommender to search for social media accounts to recommend. Additionally, the peer-to-peer recommendation system can flexibly adapt to provide notifications of recommended social media accounts to a recommendee using a variety of formats and techniques such as push notifications, text messages, or posts in an activity feed.

As illustrated by the foregoing discussion, the present disclosure utilizes a variety of terms to describe features and benefits of the peer-to-peer recommendation system. Additional detail is hereafter provided regarding the meaning of these terms as used in this disclosure. In particular, the term “recommender” refers to an individual, group, business, or other entity that recommends a social media account to a recommendee. For example, a recommender can include a user of a social networking system that recommends another social media account for a recommendee to follow. Thus, a “recommender profile” refers to a profile or account of a recommender within a social networking system associated with the peer-to-peer recommendation system.

Relatedly, the term “recommendee” refers to an individual, group, business, or other entity that receives a recommendation of a social media account from a recommender. In particular, a recommendee can include a user of a social networking system that receives a recommendation of a social media account to follow from a recommender profile. Thus, a “recommendee profile” refers to a profile or account of a recommendee within a social networking system associated with the peer-to-peer recommendation system.

As mentioned, the peer-to-peer recommendation system can utilize a recommendation engine to determine a plurality of social media accounts to provide to a recommender to recommend to a particular recommendee. As used herein, the term “recommendation engine” refers to an engine or model that predicts, determines, or generates social media accounts to provide to a recommender to recommend to a recommendee. In particular a recommendation engine can analyze input, such as recommender features and/or recommendee features, to generate an output such as a list (e.g., a ranked list) of social media accounts based on a particular architecture of the recommendation engine. Indeed, a recommendation engine can include one or more machine learning models that generate scores for social media accounts, where the scores indicate predictions of likelihoods or probabilities that a recommendee will follow the respective social media account. For example, a recommendation engine can include a neural network (e.g., a deep neural network or a convolutional neural network) that learns features (e.g., deep features) associated with recommenders and/or recommendees. The recommendation engine can include various layers, nodes, and weights for learning features (e.g., recommender features and recommendee features) and generating predictions.

Additionally, the term “feature” refers to an attribute or characteristic associated with a recommender, a recommendee, or a potential recommended social media account. Example features include, but are not limited to, age range, gender, geographic location, job title, topic of interest, followers, followees, friends, social media account activity (number and frequency of posts, shares, likes, recommendations, etc.), and engagement between profiles or accounts within a social networking system. A feature can also (or alternatively) refer to a feature such as a deep feature that is learned by the recommendation engine, where the feature is not necessarily perceivable to human observation but is learned through the various nodes, layers, and weights associated with the recommendation engine.

As mentioned, the peer-to-peer recommendation system determines and provides a plurality of social media accounts to a recommender that the recommender can choose from to recommend to a recommendee to follow. As used herein, the term “follow” (or its variations such as “follower”) refers to an indication or option for one social media account to view content posted by or otherwise associated with another social media account. For example, a follower includes a social media account that is connected with another social media account to view content posted by the other profile within a contend feed (e.g., an activity feed).

As further mentioned, the peer-to-peer recommendation system can utilize triggering criteria for determining or providing social media accounts to a recommender for recommending to a recommendee. Indeed, as used herein, the term “triggering criteria” refers to one or more mechanisms that the peer-to-peer recommendation system utilizes as a prerequisite or requirement to trigger the peer-to-peer recommendation process. For example, triggering criteria can trigger utilizing a recommendation engine to determine social media accounts to provide to a recommender profile. In some embodiments, triggering criteria can also (or alternatively) trigger providing a notification or prompt to a recommender device that includes a selectable option to recommend social media accounts to a recommendee and/or that indicates social media accounts to recommend to a user.

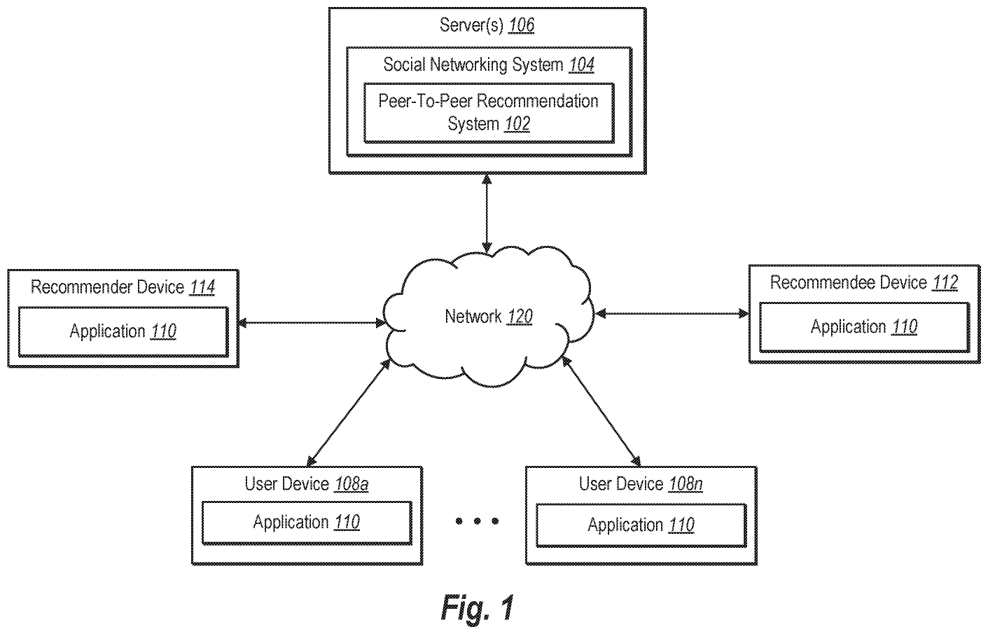

Additional detail regarding the peer-to-peer recommendation system will now be provided with reference to the figures. For example, FIG. 1 illustrates a schematic diagram of an example environment for implementing a peer-to-peer recommendation system 102 in accordance with one or more embodiments. An overview of the peer-to-peer recommendation system 102 is described in relation to FIG. 1. Thereafter, a more detailed description of the components and processes of the peer-to-peer recommendation system 102 is provided in relation to the subsequent figures.

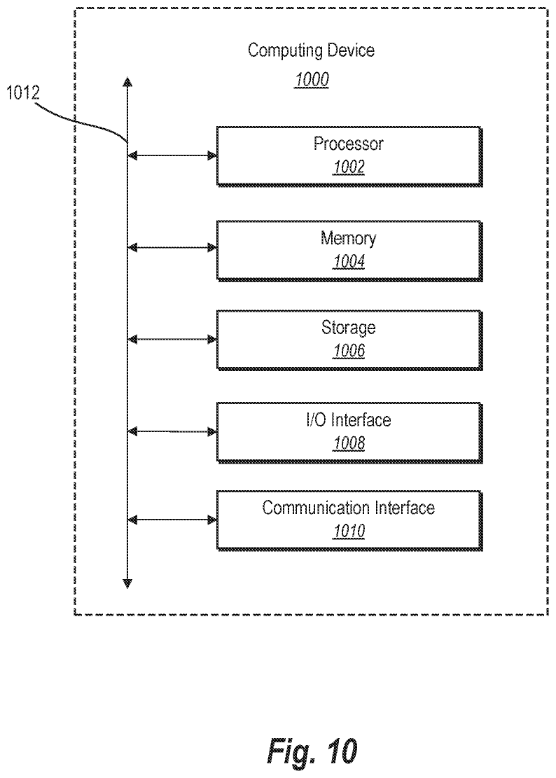

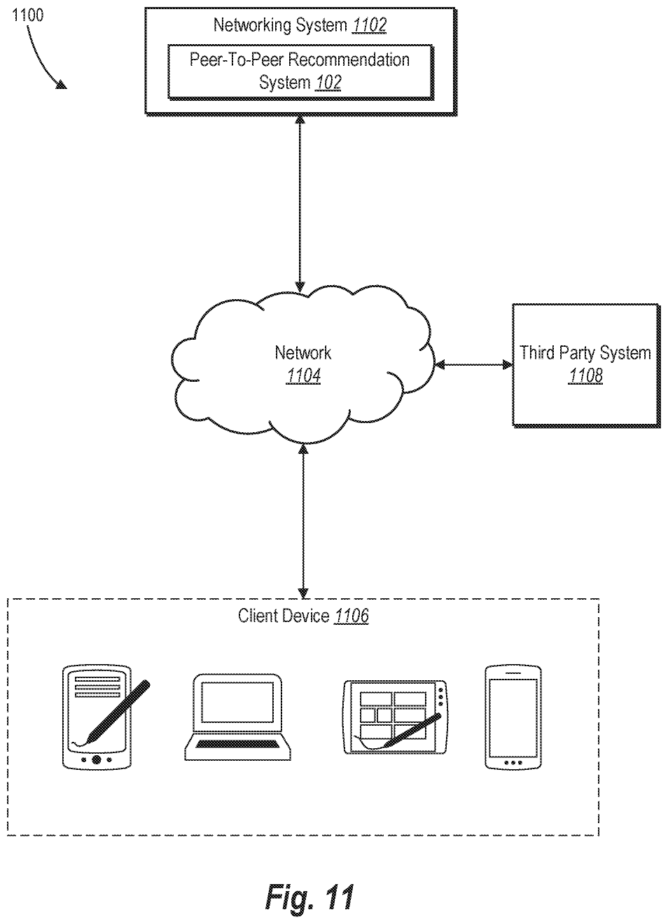

As shown in FIG. 1, the environment includes server(s) 106, user devices 108a-108n, a recommendee device, a recommender device 114, and a network 120. Each of the components of the environment can communicate via the network 120, and the network 120 may be any suitable network over which computing devices can communicate. Example networks are discussed in more detail below in relation to FIGS. 10 and 11.

As mentioned, the environment includes user devices 108a-108n. The user devices 108a-108n can be one of a variety of computing devices, including a smartphone, a tablet, a smart a television, a desktop computer, a laptop computer, a virtual reality device, an augmented reality device, or some other computing device as described in relation to FIGS. 10 and 11. FIG. 1 illustrates multiple different user devices 108a-108n, where each of the user devices 108a-108n can receive user input from users in the form of user actions such as touch gestures, clicks, etc., in relation to user interface elements displayed as part of the application 110. In some embodiments, the user devices 108a-108n are associated with users of the social networking system 104, where the users have social media accounts or user accounts registered with the social networking system 104. The user devices 108a-108n can also provide information pertaining to user input to the server(s) 106. Thus, the peer-to-peer recommendation system 102 on the server(s) 106 can receive user input information from the user devices 108a-108n to indicate actions within the application 110 for following other social media accounts or navigating within the application 110.

As also mentioned, the environment includes a recommendee device 112. In particular, the recommendee device, like the user devices 108a-108n, can be one of a variety of computing devices, including a smartphone, a tablet, a smart a television, a desktop computer, a laptop computer, a virtual reality device, an augmented reality device, or some other computing device as described in relation to FIGS. 10 and 11. The recommendee device 112 can be associated with a recommendee that has a profile (e.g., a recommendee profile) within the social networking system 104. In addition, the recommendee device 112 can receive input from a recommendee in relation to user interface elements displayed within the application 110. For example, the recommendee device 112 can receive input to select a selectable option to follow another social media account (e.g., a social media account associated with a user of user devices 108a-108n) and/or to navigate within the application 110 via touch gestures, clicks, etc. The recommendee device 112 can further communicate with the server(s) 106 to provide input information, recommendee profile information, or other information to the peer-to-peer recommendation system 102.

As further shown, the environment includes the recommender device 114. The recommender device 114 can be one of a variety of computing devices, including a smartphone, a tablet, a smart a television, a desktop computer, a laptop computer, a virtual reality device, an augmented reality device, or some other computing device as described in relation to FIGS. 10 and 11. The recommender device 114 can be associated with a recommender that has a profile (e.g., a recommender profile) within the social networking system 104. In addition, the recommender device 114 can receive input from a recommender in relation to user interface elements displayed within the application 110. For example, the recommender device 114 can receive input to select a selectable option to recommend a social media account (e.g., a social media account associated with a user of user devices 108a-108n) to a recommendee and/or to navigate (or search through other social media accounts) within the application 110 via touch gestures, clicks, etc. The recommender device 114 can further communicate with the server(s) 106 to provide input information, recommender profile information, or other information to the peer-to-peer recommendation system 102.

As shown, the user devices 108a-108n, the recommender device 114, and the recommendee device 112 include an application 110. In particular, the application 110 may be a web application, a native application installed on the user devices 108a-108n, the recommendee device 112, and/or the recommender device 114 (e.g., a mobile application, a desktop application, etc.), or a cloud-based application where all or part of the functionality is performed by the server(s) 106. The application 110 can present or display information to a user such as a recommender or a recommendee, including a social networking interface including an activity feed, a recommender user interface including options to recommend users for a recommendee to follow, or a recommendee user interface including options to follow recommended social media accounts. In some embodiments, the application 110 presents notifications of social media accounts to recommend (for the recommender) or notifications of recommended social media accounts (for the recommendee). Users such as recommenders or recommendees can interact with the application 110 to provide user input to, for example, navigate an activity feed, view and/or manage recommended social media accounts, or provide recommendations of social media accounts to follow.

As illustrated in FIG. 1, the environment includes the server(s) 106. The server(s) 106 may generate, store, process, receive, and transmit electronic data, such as recommender profile information, recommendee profile information, other social media account information, and user inputs. For example, the server(s) 106 can transmit data to the user devices 108a-108n to provide recommender user interfaces and/or recommendee user interfaces for display via the application 110. In some embodiments, the server(s) 106 comprises a content server. The server(s) 106 can also comprise an application server, a communication server, a web-hosting server, a social networking server, a digital content campaign server, or a digital communication management server.

As shown in FIG. 1, the server(s) 106 can also include the peer-to-peer recommendation system 102 (e.g., implemented as part of a social networking system 104). The social networking system 104 can communicate with the user devices 108a-108n, the recommendee device 112, and/or the recommender device 114. Although FIG. 1 depicts the peer-to-peer recommendation system 102 located on the server(s) 106, in some embodiments, the peer-to-peer recommendation system 102 may be implemented by (e.g., located entirely or in part) on one or more other components of the environment. For example, the peer-to-peer recommendation system 102 may be implemented by the recommendee device 112, the recommender device 114, the user devices 108a-108n, and/or a third-party device.

In some embodiments, though not illustrated in FIG. 1, the environment may have a different arrangement of components and/or may have a different number or set of components altogether. For example, the recommendee device 112, the recommender device 114, and/or the user devices 108a-108n may communicate directly with the peer-to-peer recommendation system 102, bypassing the network 120. Additionally, the peer-to-peer recommendation system 102 can include one or more additional databases (e.g., a social media account database) housed on the server(s) 106 or elsewhere in the environment.

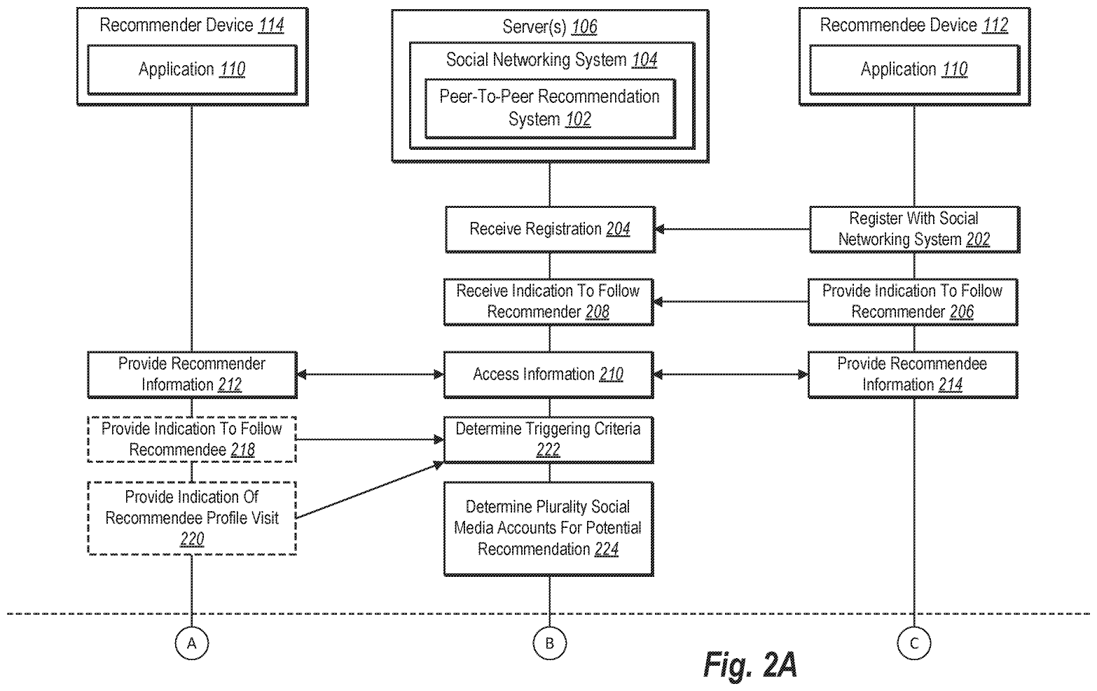

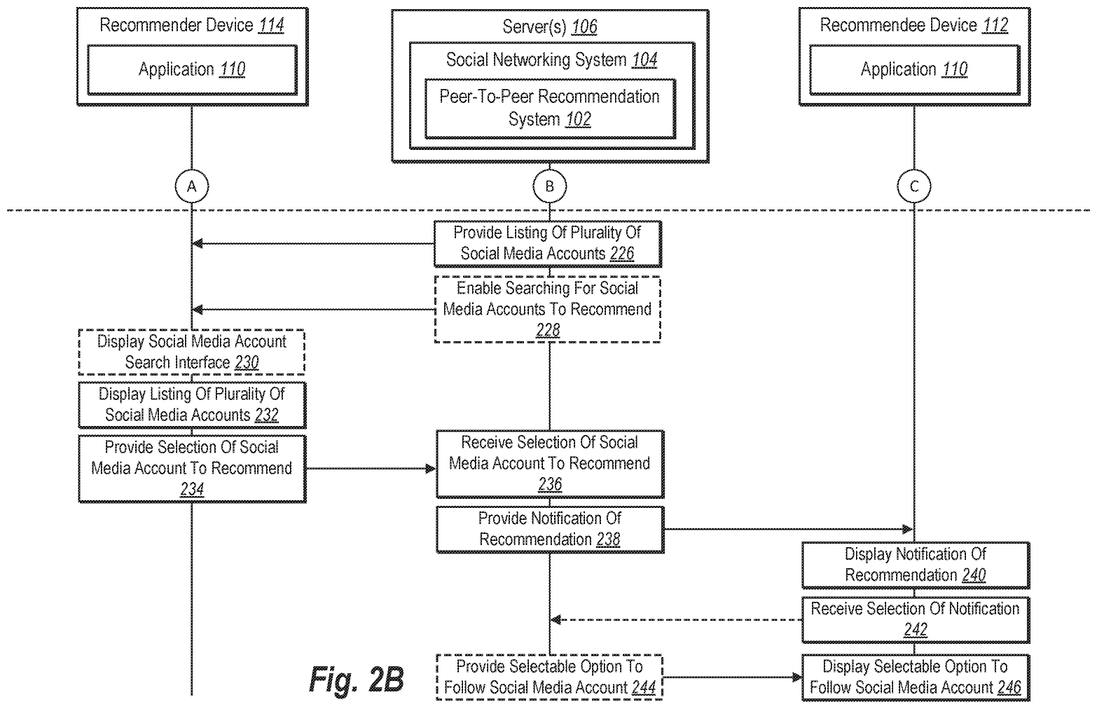

As mentioned, the peer-to-peer recommendation system 102 can determine or generate social media accounts for a recommender to recommend to a recommendee to follow. FIGS. 2A-2B illustrate an example sequence of acts performed by the recommender device 114, the peer-to-peer recommendation system 102, and/or the recommendee device 112 for generating and providing social media account recommendations. As illustrated in FIG. 2A, the peer-to-peer recommendation system performs various acts as part of the social networking system 104 on the server(s) 106.

As illustrated, the recommendee device 112 performs an act 202 to register with the social networking system 104. For example, the recommendee device 112 receives user input from a recommendee within the application 110 to activate or register a new profile/account with the social networking system 104. The recommendee device 112 further provides information to the peer-to-peer recommendation system 102 pertaining to the registration of the recommendee profile.

The peer-to-peer recommendation system 102 thus performs an act 204 to receive the registration of the recommendee profile. For example, the peer-to-peer recommendation system 102 generates and initializes a recommendee profile within the social networking system 104, whereby the recommendee can interact with other social media accounts within the social networking system 104.

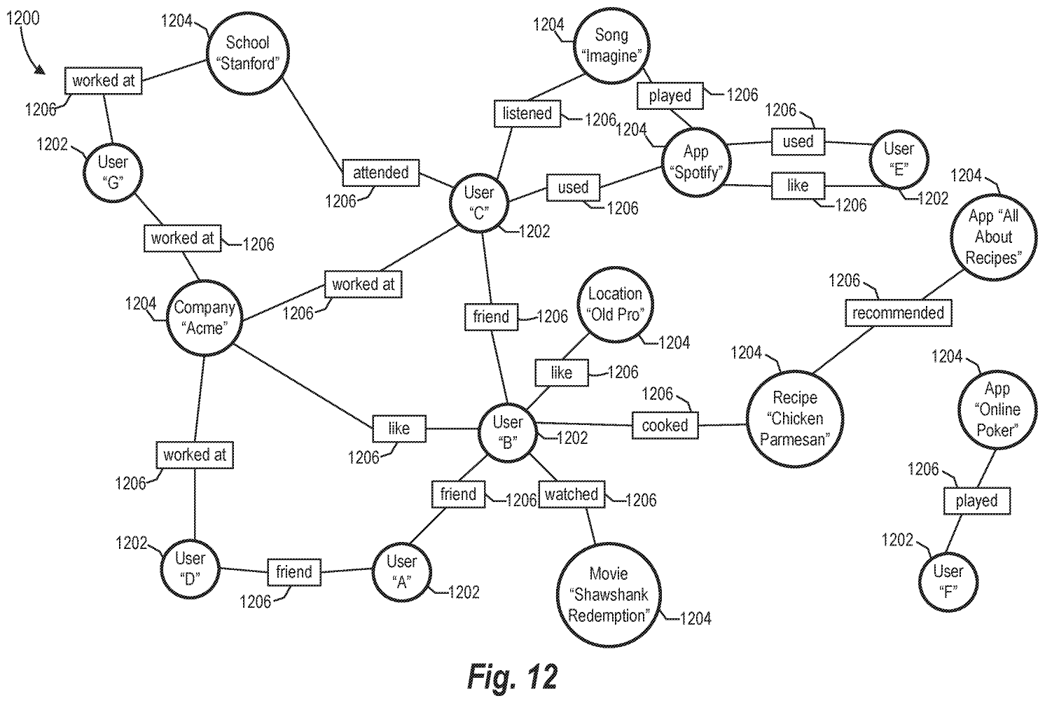

As shown, the recommendee device 112 further performs an act 206 to provide an indication to follow the recommender profile associated with the recommender device 114. In particular, the recommendee device 112 receives user input in the form of a selection of a follow option and provides an indication of the user selection to the peer-to-peer recommendation system 102. In response, the peer-to-peer recommendation system 102 performs an act 208 to receive the indication to follow the recommender profile. Based on the follow indication, the peer-to-peer recommendation system 102 can further connect the recommendee profile with the recommender profile such that the peer-to-peer recommendation system 102 populates an activity feed associated with the recommendee profile with posts (or other actions or information) associated with the recommender profile as described in greater detail below in reference to FIGS. 11 and 12. Indeed, the peer-to-peer recommendation system 102 determines that the recommendee profile is a follower of the recommender profile.

As further illustrated in FIG. 2A, the peer-to-peer recommendation system 102 performs an act 210 to access information. In particular, the peer-to-peer recommendation system 102 accesses recommender information from the recommender device 114 and recommendee information from the recommendee device 112. The recommender device 114 performs an act 212 to provide recommender profile information to the peer-to-peer recommendation system 102, and the recommendee device 112 performs an act 214 to provide recommendee profile information to the peer-to-peer recommendation system 102. For example, the peer-to-peer recommendation system 102 accesses recommender features such as topics of interest, connected social media accounts (e.g., friends, profiles the recommender follows, and followers), profile activity, gender, location, etc. The peer-to-peer recommendation system 102 further accesses recommendee features such as topics of interest, connected social media accounts (e.g., friends, profiles the recommendee follows, and followers), profile activity, gender, location, etc. In the same or other embodiments, the peer-to-peer recommendation system 102 accesses potential recommended social media account features such as topics of interest, connected social media accounts (e.g., friends, profiles the recommender follows, and followers), profile activity, gender, location, etc. associated with other social media accounts that the peer-to-peer recommendation system 102 may potentially provide as suggested recommendations.

Based at least in part on the recommender features and the recommendee features, the peer-to-peer recommendation system 102 performs an act 222 to determine triggering criteria to prevent spamming of social media account recommendations. Particularly, the peer-to-peer recommendation system utilizes triggering criteria for determining and/or providing social media accounts to the recommender device 114 to recommend to the recommendee profile. Indeed, the peer-to-peer recommendation system 102 determines triggering criteria based on the recommender features, the potential recommended social media account features, and/or the recommendee features in addition (or alternatively) to other information such as an age of the recommendee profile, recommender actions, recommendee actions, and/or timing of the recommender/recommendee actions.

To elaborate, before providing social media accounts for the recommender profile to recommend to the recommendee profile, the peer-to-peer recommendation system 102 determines triggering criteria such as an activity level of the recommender account. For instance, the peer-to-peer recommendation system 102 determines, for a given time period (e.g., the previous month), how many days the recommender profile has been active (e.g., where the recommender has performed one or more actions within the profile). Upon determining that the recommender profile has been active for at least a threshold number of days within a time period (e.g., half of the days in the past month), the peer-to-peer recommendation system 102 determines that the triggering criterion is satisfied.

Additionally, the peer-to-peer recommendation system 102 analyzes other recommender features for determining triggering criteria. For example, the peer-to-peer recommendation system 102 determines a number of followers associated with the recommender profile. Based on determining that the recommender profile has fewer (or up to) a threshold number of followers (e.g., 1000, 3500, or 5000), the peer-to-peer recommendation system 102 determines that the triggering criterion is satisfied.

In some embodiments, the peer-to-peer recommendation system 102 utilizes other recommender-specific triggering criteria as well (or in the alternative). For example, in some embodiments the peer-to-peer recommendation system 102 monitors activity associated with the recommender profile to determine whether the recommender visits the recommendee profile and/or follows the recommendee profile. Indeed, in some embodiments the peer-to-peer recommendation system 102 utilizes a determination that the recommender profile follows the recommendee profile after the recommendee profile follows the recommender profile as a triggering criterion. As shown in FIG. 2A, in some embodiments, the recommender device 114 can perform an act 218 to provide an indication that the recommender has selected an option to follow the recommendee profile. In these or other embodiments, the peer-to-peer recommendation system 102 utilizes a determination that the recommender profile visits the recommendee profile as a triggering criterion. For instance, in some embodiments, the recommender device 114 can perform an act 220 to provide an indication that the recommender visits the recommendee profile.

The peer-to-peer recommendation system 102 further determines triggering criteria based on recommendee features. In particular, the peer-to-peer recommendation system 102 determines a recency or an age associated with the recommendee profile to utilize as a triggering criterion. For example, the peer-to-peer recommendation system 102 determines how long the recommendee profile has existed or has been registered within the social networking system 104. Based on determining that the recommendee profile has been registered for less than (or up to) a threshold duration of time (e.g., 7 days or 1 month), the peer-to-peer recommendation system 102 determines that the triggering criterion is satisfied.

In some embodiments, the peer-to-peer recommendation system 102 analyzes additional recommendee profile information such as a number of other social media accounts that the recommendee profile has followed. Thus, based on determining that the recommendee profile has followed fewer than (or up to) a threshold number of other social media accounts, the peer-to-peer recommendation system 102 determines that the triggering criteria is satisfied. In these or other embodiments, the peer-to-peer recommendation system 102 monitors activity associated with the recommendee profile to determine that, as a triggering criterion, the recommendee profile is a current follower of the recommender profile.

As mentioned, the peer-to-peer recommendation system 102 can determine and/or utilize multiple triggering criteria together to trigger providing social media accounts to the recommender device 114. In some embodiments, the peer-to-peer recommendation system 102 utilizes a particular combination of triggering criteria. For example, in some embodiments the peer-to-peer recommendation system 102 determines that the recommendee profile is a follower of the recommender profile and either 1) the recommender profile visits the recommendee profile or 2) the recommender follows the recommendee profile after the recommendee profile has followed the recommender profile. In addition (or alternatively), the peer-to-peer recommendation system 102 determines that the recommender profile has been active for at least a threshold number of days over a time period and that the recommender profile has fewer than a threshold number of followers. Additionally still, the peer-to-peer recommendation system 102 determines that the recommendee profile is a newly registered profile (within a threshold recency) and is a profile that has followed fewer than a threshold number of other social media accounts.

The peer-to-peer recommendation system 102 can also (or alternatively) determine other triggering criteria. For example, the peer-to-peer recommendation system 102 can determine that a recommendee is currently viewing the recommender profile to enable the recommender to recommend other social media accounts to the recommendee. As another example, the peer-to-peer recommendation system 102 can determine timing information pertaining to the recommender profile and/or recommendee profile. For example, in some embodiments the peer-to-peer recommendation system 102 determines that a threshold duration of time (e.g., 24 hours) has elapsed before providing a prompt for a recommender to recommend social media accounts for a recommendee to follow.

Additionally, the peer-to-peer recommendation system 102 can implement or utilize other spam prevention techniques. For example, in some embodiments the peer-to-peer recommendation system 102 limits the number of social media accounts that the recommender can recommend to a recommendee. In particular, the peer-to-peer recommendation system 102 utilizes a threshold number of social media accounts (e.g., 10, 15, or 20) that a recommender can recommend to a recommendee either in total or within a given time period (e.g., 1 day, 1 week, or 1 month, ever). In the same or other embodiments, the peer-to-peer recommendation system 102 utilizes a time delay before enabling a recommender to provide any recommendations to a recommendee profile. For example, the peer-to-peer recommendation system 102 utilizes a delay of a particular duration of time (e.g., 1 minute or 2 minutes) before providing a prompt to a recommender including an option whereby the recommender can provide recommendations to the recommendee. In some embodiments, for instance, the peer-to-peer recommendation system 102 utilizes the time delay as a triggering criteria.

As illustrated in FIG. 2A, the peer-to-peer recommendation system 102 further performs an act 224 to determine, via a recommendation engine, a plurality of social media accounts for potential recommendation. In particular, the peer-to-peer recommendation system 102 utilizes a recommendation engine to analyze recommender features and recommendee features to generate or determine a plurality of social media accounts to provide to the recommender. For example, the peer-to-peer recommendation system 102 monitors recommender profile activity and recommendee profile activity to determine interactions with other social media accounts, including when those interactions occur. The peer-to-peer recommendation system 102 further utilizes a recommendation engine to determine a plurality of social media accounts for the recommender profile to recommend to the recommendee profile based on profile activity information and other recommender/recommendee features.

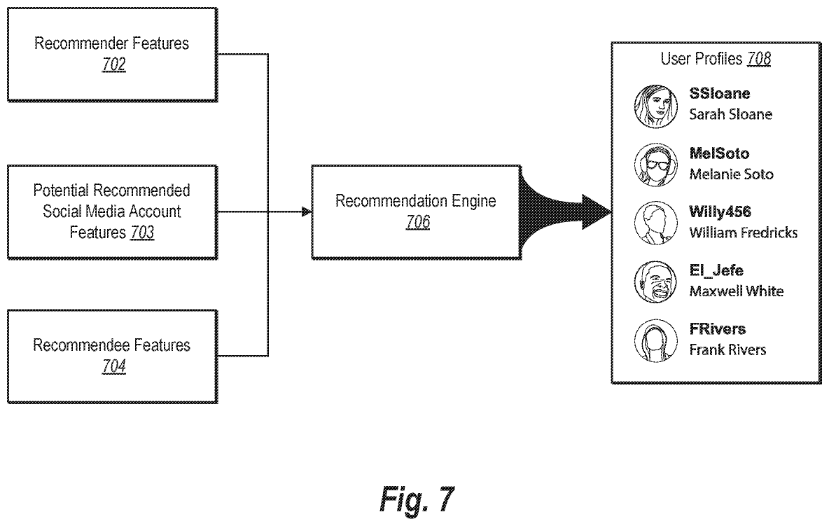

For example, the peer-to-peer recommendation system 102 utilizes the recommendation engine to, based on recommender features and recommendee features, determine scores for other social media accounts within a profile database (associated with the social networking system 104). In particular, the peer-to-peer recommendation system 102 determines scores that indicate a probability or likelihood of the recommender following respective social media accounts. Indeed, the peer-to-peer recommendation system 102 determines the scores by applying the recommendation engine to analyze various recommender features and recommendee features. In some embodiments, the recommendation engine generates a ranked listing of a plurality of users to recommend to a recommendee. Additional detail regarding utilizing the recommendation engine to generate a plurality of users is provided below with reference to FIG. 7.

Continuing the sequence of acts from FIG. 2A to FIG. 2B, the peer-to-peer recommendation system 102 performs an act 226 to provide the list of the plurality of social media accounts to the recommender device 114. In some embodiments, however, the peer-to-peer recommendation system 102 provides a prompt to the recommender device 114 before then providing the plurality of social media accounts. For example, the peer-to-peer recommendation system 102 provides a selectable option to recommend social media accounts to the recommendee profile. In response to detecting or receiving indication of a selection of the option to recommend social media accounts, the peer-to-peer recommendation system 102 provides, for display within a recommender user interface presented as part of the application 110 on the recommender device 114, a listing (e.g., a ranked listing) of the plurality of users determined by the recommendation engine.

In some embodiments, the peer-to-peer recommendation system 102 further performs an act 228 to enable the recommender to search for social media accounts to recommend. For example, the peer-to-peer recommendation system 102 enables the recommender to search from among the plurality of social media accounts determined by the recommendation engine (e.g., via a text query search or by scrolling through the listing of social media accounts). In other embodiments, the peer-to-peer recommendation system 102 enables the recommender to search through other social media accounts such as profiles associated with the recommender profile or the recommendee profile. In these or other embodiments, the peer-to-peer recommendation system 102 enables the recommender to search through a database of social media accounts associated with the social networking system 104.

To enable the recommender to search for social media accounts, the peer-to-peer recommendation system 102 provides a search option (e.g., a text query box) within a recommender user interface. Indeed, as shown in FIG. 2B, the recommender device 114 performs an act 230 to display the profile search option within a recommender user interface. In response to receiving a search query from the recommender (as provided by the recommender device 114), the peer-to-peer recommendation system 102 searches social media accounts (e.g., from among those identified by the recommendation engine or from a general profile database) to identify any additional social media accounts that match the search query. Based on an input from the recommender, the peer-to-peer recommendation system 102 further modifies the plurality of social media accounts determined by the recommendation engine to add or include the social media account(s) identified via the search.

As illustrated, the recommender device 114 performs an act 232 to display the listing of the plurality of social media accounts based on receiving the listing from the peer-to-peer recommendation system 102. For example, the recommender device 114 displays a recommender user interface including the listing of the social media accounts. In particular, the recommender device displays a ranked listing of social media accounts together with other user interface elements such as a search option and respective selectable recommend options to recommend the listed social media accounts to the recommendee profile.

Based on receiving an input from a recommender to select a social media account within the listing of social media accounts to recommend, the peer-to-peer recommendation system 102 can perform an act 234 to provide the selection of the social media account to recommend. In particular, the peer-to-peer recommendation system 102 receives a touch gesture or a click of a recommend option relative to a listed social media account and provides an indication of the selection to the peer-to-peer recommendation system 102. Thus, the peer-to-peer recommendation system 102 performs an act 236 to receive the selection of the social media account to recommend to the recommendee profile from the recommender device 114. In some embodiments, the peer-to-peer recommendation system 102 receives an indication of multiple profiles to recommend to the recommendee (e.g., in cases where recommender selects multiple social media accounts from the listing).

Based on receiving the indication of the social media account to recommend, the peer-to-peer recommendation system 102 performs an act 238 to provide a notification of the recommendation to the recommendee device 112. For example, the peer-to-peer recommendation system 102 provides a notification for display within a recommendee user interface presented in the recommendee device 112. In some embodiments, the peer-to-peer recommendation system 102 provides a notification for display within an activity feed or a news feed. In these or other embodiments, the peer-to-peer recommendation system 102 provides a notification in the form of an email, a text message, native application notification, or an instant message. In the same or other embodiments, the notification is selectable by the recommendee.

In some embodiments, the notification is an aggregated notification, where the peer-to-peer recommendation system 102 modifies or updates the notification in response to additional recommender input to add and/or remove social media accounts to recommend to the recommendee profile. For example, as part of (or in addition to) the act 238, the peer-to-peer recommendation system 102 utilizes a delay of a particular duration (e.g., 2 minutes) before providing the notification to the recommendee device 112. Indeed, the peer-to-peer recommendation system 102 waits a delay duration for the recommender to add and/or remove social media accounts to provide to the recommendee device. In some embodiments, rather than wait for a delay, the peer-to-peer recommendation system 102 provides the notification immediately and further modifies the provided notification in response to the recommender adding and/or removing social media accounts to recommend. Thus, the recommendee device 112 displays changes to the notification within a recommendee user interface as the notification is modified.

In some embodiments, as part of (or in addition to) the act 238, the peer-to-peer recommendation system 102 determines to provide the notification to the recommendee device 112 based on detecting that the recommender device 114 is no longer displaying or utilizing a recommender user interface. Indeed, the peer-to-peer recommendation system 102 determines that the recommender device 114 has exited a recommendation flow for recommending social media accounts (e.g., by detecting that the recommender device 114 is no longer displaying a recommender user interface), and the peer-to-peer recommendation system 102 further provides the notification to the recommendee device 112 upon such a determination.

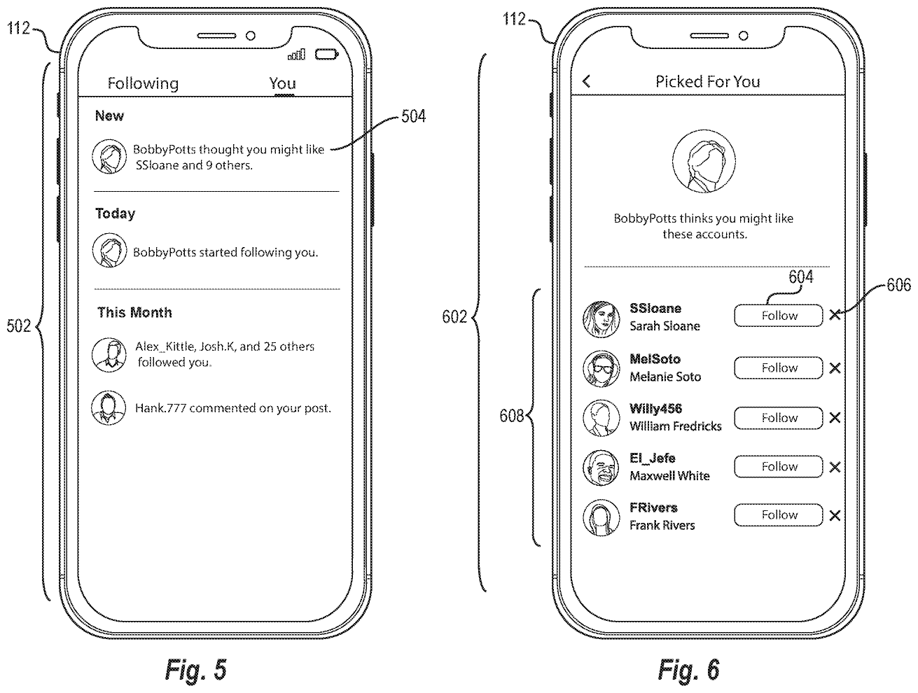

As illustrated in FIG. 2B, the recommendee device 112 performs an act 240 to display a notification received from the peer-to-peer recommendation system 102. To elaborate, recommendee device 112 displays the notification within an activity feed or a news feed associated with the social networking system 104. For example, upon receiving the notification from the peer-to-peer recommendation system 102, the recommendee device 112 updates an activity feed of the recommendee profile to display the notification (e.g., as part of a timeline). In some embodiments, the recommendee device 112 displays the notification as a push notification or a popup notification. Additional detail regarding displaying the notification is provided below with reference to FIG. 5.

As shown, the recommendee device 112 performs an act 242 to receive or detect a selection of the notification. For example, the recommendee device 112 receives a user input such as a touch gesture or a click to select the notification within an activity feed. Based on the selection, in some embodiments, the recommendee device 112 provides an indication of the selection to the peer-to-peer recommendation system 102. In response to receiving the indication of the selection, the peer-to-peer recommendation system 102 performs an act 244 to provide a selectable option to follow the recommended social media account(s) for display within a recommendee user interface presented on the recommendee device 112.

Indeed, the recommendee device 112 performs an act 246 to display the selectable option to follow the recommended social media account within a recommendee user interface. For instance, in response to the selection of the notification, the recommendee device 112 navigates to a recommendee user interface (e.g., as part of an activity feed or independent from the activity feed) to display indications of recommended social media account(s) together with corresponding selectable options for the recommendee profile to follow. In some embodiments, however, the recommendee device 112 need not provide an indication of a selection to the peer-to-peer recommendation system 102 to then display the recommendee user interface including the selectable option to follow the recommender social media account(s). Instead, the recommendee device 112 performs the act 246 based on the act 242 of receiving the selection of the notification. Based on detecting a selection of an option to follow a social media account, the peer-to-peer recommendation system 102 modifies the recommendee profile to make the recommendee profile a follower of the social media account. Additional detail regarding the recommendee user interface is provided below with reference to FIG. 6.

As mentioned, the peer-to-peer recommendation system 102 utilizes triggering criteria to determine whether to provide social media accounts to a recommender device (e.g., the recommender device 114) to recommend to a recommendee profile to follow or otherwise initiate a peer-to-peer recommendation process. For example, the peer-to-peer recommendation system 102 determines that, after the recommendee profile follows the recommender profile, the recommender follows the recommendee profile back. Indeed, FIG. 3 illustrates an example portrayal of the recommender device 114 including a notification 302 that a recommendee (“Sergei Volkov”) has followed the recommender profile.

As shown, the peer-to-peer recommendation system 102 provides the notification 302 for display via the recommender device 114. The notification 302 includes information about the recommendee profile such as a job title (“Photographer”), a privacy indication for the recommendee profile, a number of followers, and a number of social media accounts following the recommendee profile. In some embodiments, the peer-to-peer recommendation system 102 provides a different form of notification such as a notification within an activity feed of the recommender profile that the recommendee profile has followed the recommender profile. In these embodiments, the peer-to-peer recommendation system 102 (or the recommender device 114) detects a selection of the notification to then provide, for display, the notification 302 including the information pertaining to the recommendee profile.

As further shown in FIG. 3, the notification 302 includes a selectable option 304 to follow the recommendee profile back. Indeed, the peer-to-peer recommendation system 102 determines that the recommendee profile is already a follower of the recommender profile to provide the option 304 as a “Follow Back” option.

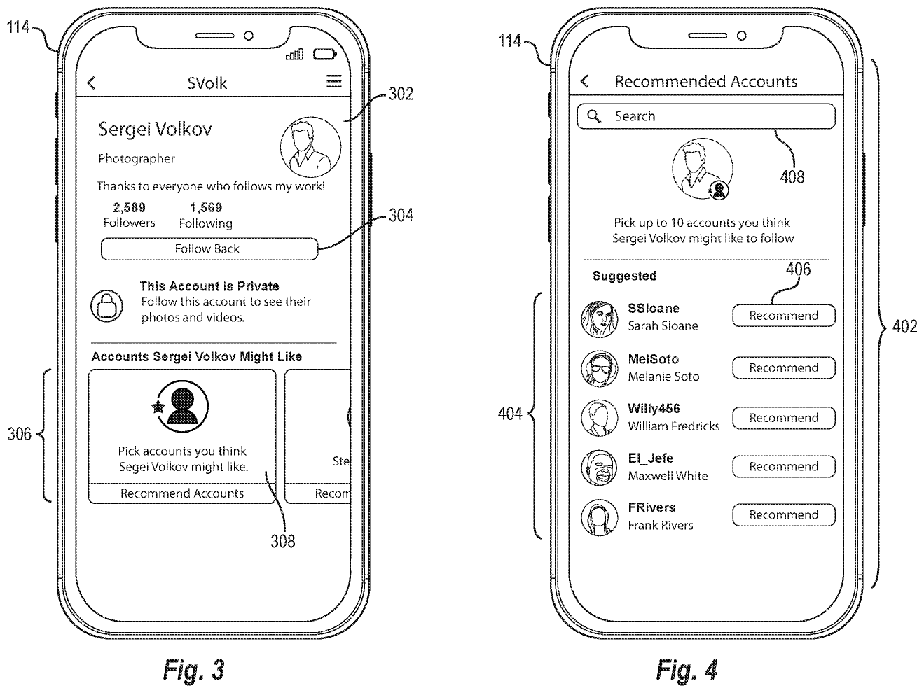

In addition, the peer-to-peer recommendation system 102 provides one or more social media accounts that the recommendee profile may be interested in following. Indeed, as shown in FIG. 3, the recommender device 114 displays (as provided by the peer-to-peer recommendation system 102) a listing 306 of social media accounts. In some embodiments, the listing 306 is side-scrollable based on user input to swipe sideways through the listing 306 to view the social media accounts. In these or other embodiments, the peer-to-peer recommendation system 102 provides the listing 306 without selectable options to follow any of the social media accounts until the triggering criteria are satisfied. Indeed, the peer-to-peer recommendation system 102 refrains from providing selectable recommend options until the triggering criteria are met. For instance, upon detecting a selection of the follow back option 304 (in addition to other triggering criteria described above), the peer-to-peer recommendation system 102 provides selectable options to recommend social media accounts to the recommendee profile (e.g., within the listing 306 or within a different user interface such as the recommender user interface 402 of FIG. 4).

Within the listing 306, the peer-to-peer recommendation system 102 provides a selectable option 308 for display via the recommender device 114 for picking accounts to recommend to the recommender profile. In some embodiments, however, the peer-to-peer recommendation system 102 provides the option 308 separate from the listing 306. In these or other embodiments, the peer-to-peer recommendation system 102 provides the option 308 only upon determining that the triggering criteria are satisfied. In any event, the peer-to-peer recommendation system 102 receives an indication of a selection of the option 308, whereupon the peer-to-peer recommendation system 102 (or the recommender device 114) provides a recommender user interface (e.g., the recommender user interface 402 of FIG. 4) for facilitating the selecting and recommending of social media accounts to the recommendee profile.

In some embodiments, the peer-to-peer recommendation system 102 waits for an expiration of a duration of time (e.g., 24 hours) after detecting selection of the follow back option 304 (or determining other triggering criteria) before providing any social media accounts (e.g., the listing 306) to the recommender device 114 for the recommender to recommend. In the same or other embodiments, the peer-to-peer recommendation system 102 waits for an expiration of a duration of time after determining triggering criteria before providing a selectable option to recommend social media accounts (e.g., the option 308).

For example, FIG. 4 illustrates a recommender user interface 402 displayed via the recommender device 114 whereby a recommender can select one or more social media accounts from a listing 404 of social media accounts generated by the peer-to-peer recommendation system 102. Indeed, the peer-to-peer recommendation system 102 generates the listing 404 of social media accounts based on utilizing a recommendation engine, as mentioned above and as described in further detail below with reference to FIG. 7. For example, the peer-to-peer recommendation system 102 utilizes the recommendation engine to generate the listing 404 as a ranked list of social media accounts associated with the recommender profile and/or the recommendee profile.

In providing the recommender user interface 402, the peer-to-peer recommendation system 102 enables the recommender to select social media accounts to recommend to the recommendee. In some embodiments, the peer-to-peer recommendation system 102 limits the number of social media accounts that the recommender can recommend. As indicated in FIG. 4, for instance, the recommender user interface 402 prompts the recommender to “Pick up to 10 accounts you think Sergei Volkov might like to follow.” In some, the peer-to-peer recommendation system 102 generates the listing 404 to only include a threshold number of social media accounts so that the recommender cannot recommend more than the number provided within the listing 404. In other embodiments, the peer-to-peer recommendation system 102 prevents the recommender from recommending more than a threshold number of social media accounts by removing any selectable recommend options (e.g., the recommend option 406) once the recommender has selected the threshold number of options for recommending social media accounts.

In providing the listing 404, the peer-to-peer recommendation system 102 utilizes a recommendation engine to generate social media accounts to provide to the recommender profile for recommending to the recommendee profile, as mentioned above. In some embodiments, the peer-to-peer recommendation system 102 ranks the social media accounts within the listing 404, where the highest ranked social media account (“Sarah Sloane”) appears at the top of the listing 404. For example, the peer-to-peer recommendation system 102 utilizes a recommendation engine to rank the social media accounts based on various factors such as a closeness to the recommender profile and a usefulness to the recommendee profile. Indeed, the peer-to-peer recommendation system 102 utilizes a recommendation engine to generate scores for the social media accounts based on one or more factors.

For instance, the recommendation engine utilizes a combination of a closeness factor with respect to a recommender profile and a potential closeness factor with respect to the recommendee profile. In some embodiments, the peer-to-peer recommendation system 102 determines the closeness factor for the recommendation engine based on recommender features and potential recommended social media account features. In these or other embodiments, the peer-to-peer recommendation system 102 determines the potential closeness factor based on recommendee profile features and potential recommended social media account features.

In addition, the peer-to-peer recommendation system 102 ranks the social media accounts based on their respective scores. For example, in some embodiments, the peer-to-peer recommendation system 102 ranks the social media accounts based on which social media accounts the recommender and/or recommendee profile have followed. In addition (or alternatively), the peer-to-peer recommendation system 102 ranks the social media accounts in order of which social media accounts the recommender and/or recommendee have most interacted with (or most frequently or most recently interacted with). In these or other embodiments, the peer-to-peer recommendation system 102 ranks the social media accounts based on the scores which indicate a probability of the recommendee profiles following the respective social media accounts based on recommendee features and/or recommender features, as described above.

For example, the peer-to-peer recommendation system 102 scores social media accounts to provide to the recommender based on shared topics of interest between the social media accounts and the recommender/recommendee profile, shared topics of interest between the social media accounts and the recommender/recommendee profile, similar geographic locations of the social media accounts relative to the recommender and/or recommendee, or other factors relating to various nodes and edges of the social networking system 104. Additional detail regarding example nodes and edges is provided below with reference to FIG. 12.

In some embodiments, the listing 404 of social media accounts is dynamic. To elaborate, the peer-to-peer recommendation system 102 modifies or updates the list based on changes to recommender features and/or recommendee features. For example, the peer-to-peer recommendation system 102 utilizes a recommendation engine to modify the listing 404 based on monitoring activity associated with the recommendee profile and/or the recommender profile. Indeed, based on detecting new interactions with other social media accounts, new follows, new followers, and/or other changes to recommender features and/or recommendee features, the peer-to-peer recommendation system 102 updates listing 404 to remain current or up-to-date. In some embodiments, the peer-to-peer recommendation system 102 re-applies a recommendation engine with each new detected change to recommender/recommendee features. In other embodiments, the peer-to-peer recommendation system 102 applies a recommendation engine at particular intervals (e.g., every 5 minutes, every 10 minutes, or every hour) to update the listing 404 of social media accounts.

As illustrated in FIG. 4, the peer-to-peer recommendation system 102 (or the recommender device 114) provides a search option 408 within the recommender user interface 402. Indeed, the peer-to-peer recommendation system 102 provides a search option 408 in the form of a search bar whereby the recommender can enter a search query to search for social media accounts to recommend to the recommendee. Based on receiving a search query, the peer-to-peer recommendation system 102 searches for social media accounts that match (or are otherwise returned by) the search query. For example, in some embodiments, the peer-to-peer recommendation system 102 searches the listing 404 (the listing 404 can be scrollable to view social media accounts not shown within a current view of the recommender user interface 402) for social media accounts based on the search query. In other embodiments, the peer-to-peer recommendation system 102 searches a database of social media account information associated with the social networking system 104 to identify social media accounts to recommend in addition (or alternatively) to those within the listing 404.

Based on receiving an input to select the recommend option 406, the peer-to-peer recommendation system 102 provides a notification to the recommendee device 112 of the recommended social media account from the recommender profile. As mentioned, in some embodiments, the peer-to-peer recommendation system 102 waits a delay duration before providing the notification to enable the recommender to select and/or remove other social media accounts for recommending to the recommendee. Indeed, the peer-to-peer recommendation system 102 continues to provide the recommender user interface 402 to the recommender device 114 until expiration of the delay duration to allow the recommender enough time to select additional social media accounts to recommend if desired.

In some embodiments, rather than (or in addition to) using a delay, the peer-to-peer recommendation system 102 detects when the recommender device 114 is no longer displaying the recommender user interface 402 to then provide the notification to the recommendee device 112. In these or other embodiments, the peer-to-peer recommendation system 102 provides an additional selectable option (e.g., a “Submit” option) within the recommender user interface 402 upon detecting a selection of one or more recommend options (e.g., the recommend option 406). Based on a selection of the Submit option, the peer-to-peer recommendation system 102 provides a notification of the recommendation(s) to the recommendee device 112.

Indeed, FIG. 5 illustrates an example portrayal of the recommendee device 112 displaying a notification 504 that the recommender profile (“BobbyPotts”) has recommended 10 profiles (“SSloane and 9 others”) to the recommendee profile. As shown, the peer-to-peer recommendation system 102 provides the notification 504 to the recommendee device 112 for display as an item within an activity feed 502. Indeed, the recommendee device 112 displays the activity feed 502 as a listing of received notifications for the recommendee profile. While FIG. 5 illustrates the notification 504 within the activity feed 502, in some embodiments the peer-to-peer recommendation system 102 provides a different type of notification such as a push notification or a text message.

As shown in FIG. 5, the peer-to-peer recommendation system 102 provides the notification 504 in the form of an aggregated notification. Indeed, the notification 504 displays a combination or aggregation of multiple independent items or actions such as, for example, the recommender selecting 10 different social media accounts to recommend to the recommendee. In some embodiments, the peer-to-peer recommendation system 102 modifies or updates the notification 504 as it is displayed within the activity feed 502. For instance, as the peer-to-peer recommendation system 102 receives indications of additions or deletions of social media accounts to recommend, the peer-to-peer recommendation system 102 modifies the notification 504 to display up-to-date recommendation information to the recommendee. To illustrate from FIG. 5, if the peer-to-peer recommendation system 102 receives, from the recommender device 114, an indication to remove a social media account (not “S Sloane”) as a recommendation to the recommendee, the peer-to-peer recommendation system 102 updates the notification 504 to read “BobbyPotts thought you might like S Sloane and 8 others.”

Further, in some embodiments, the notification 504 is interactive. For example, the notification can be scrollable (via a swipe gesture or a tap-and-hold gesture followed by a swipe gesture) and/or selectable (via a tap gesture). Indeed, the peer-to-peer recommendation system 102 (or the recommendee device 112) enables the recommendee to scroll through the recommended social media accounts directly from the activity feed 502 by swiping sideways on the notification 504 through various recommended social media accounts (e.g., in ranked order or in time-wise order of their recommendations from the recommender device 114). The peer-to-peer recommendation system 102 further provides corresponding selectable follow options in relation to the social media accounts for the recommendee to follow the individual recommended social media accounts.

In some embodiments, the peer-to-peer recommendation system 102 (or the recommendee device 112) receives a tap-and-hold gesture (or a force touch gesture) on the notification 504 to display a popup interface (e.g., a popup recommendee user interface) as an overlay over the notification 504 and/or the activity feed 502, wherein the popup interface includes a scrollable listing of the recommended social media accounts in ranked or time-wise order, together with selectable options to follow the social media accounts. In these or other embodiments, the peer-to-peer recommendation system 102 (or the recommendee device 112) receives or detects a selection of the notification 504 to provide a recommendee user interface such as the recommendee user interface 602 of FIG. 6.

Indeed, FIG. 6 illustrates the recommendee device 112 displaying a recommendee user interface 602 including a listing 608 of the social media accounts recommended by the recommender profile. In some embodiments, the peer-to-peer recommendation system 102 provides the listing 608 for display in order of respective rankings of the social media accounts, while in other embodiments the peer-to-peer recommendation system 102 provides the listing 608 for display in order that the respective social media accounts were selected for recommendation by the recommender.

In addition to the listing 608 of social media accounts, the peer-to-peer recommendation system 102 (or the recommendee device 112) also provides selectable follow options (e.g., the follow option 604) to follow the corresponding social media accounts. For example, upon detecting or receiving a selection of the follow option 604, the peer-to-peer recommendation system 102 modifies the recommendee profile and the newly-followed social media account to indicate that the recommendee profile is now a follower of the social media account. In some embodiments, the peer-to-peer recommendation system 102 provides notifications of activities of the social media account within an activity feed (e.g., the activity feed 502) of the recommendee profile. In addition to the follow option 604, the peer-to-peer recommendation system 102 further provides remove options such as the remove option 606 to remove social media accounts from the listing 608. Based on a selection of the remove option 606, the peer-to-peer recommendation system 102 (or the recommendee device 112) removes the corresponding social media account (“SSloane”) from the listing 608.

As mentioned, the peer-to-peer recommendation system 102 utilizes a recommendation engine to generate a plurality of social media accounts to provide to a recommender profile for recommending to a recommendee profile. Indeed, FIG. 7 illustrates an example flow of implementing a recommendation engine 706 to generate a plurality of social media accounts 708 associated with the recommender profile and/or the recommendee profile. In particular, the peer-to-peer recommendation system 102 utilizes the recommendation engine 706 to analyze recommender features 702, potential recommended social media account features 703, and/or recommendee features 704 to generate an output of a listing of social media accounts 708 (e.g., the same social media accounts within the listing 404). In some embodiments, the recommendation engine 706 outputs a ranked listing of the social media accounts 708 based on assigning scores to various social media accounts associated with the social networking system 104.

In one or more embodiments, the peer-to-peer recommendation system 102 determines scores (e.g., affinity scores) for social media accounts by utilizing the recommendation engine 706 to analyze the recommender features 702, potential recommended social media account features 703, and/or the recommendee features 704. Indeed, the peer-to-peer recommendation system 102 can determine scores between connected users and/or between unconnected users. For instance, the recommendation engine 706 determines scores that indicate probabilities that, for respective social media accounts, the recommendee will follow the social media accounts. For example, the recommendation engine 706 generates scores based on social media accounts that the recommender or the recommendee have most interacted with. In these or other embodiments, the recommendation engine 706 determines scores for social media accounts that the recommender or the recommendee have most frequently (based on a number of interactions over a time period) or most recently interacted with.

In some embodiments, the recommendation engine 706 utilizes a combination of a closeness factor with respect to a recommender profile and a potential closeness factor with respect to the recommendee profile to determine scores for social media accounts. In these or other embodiments, the peer-to-peer recommendation system 102 determines the closeness factor for the recommendation engine based on recommender features and potential recommended social media account features. In these or other embodiments, the peer-to-peer recommendation system 102 determines the potential closeness factor based on recommendee profile features and potential recommended social media account features.

In some embodiments, the recommendation engine 706 includes one or more heuristic models. For example, the recommendation engine 706 utilizes a heuristic approach to determine a score based on the recommender features 702 and potential recommended social media account features 703. As another example, the recommendation engine 706 utilizes a heuristic approach to determine a score based on a combination (e.g., a summation) of a first sub-score and a second sub-score. In some embodiments, the first sub-score is based on the recommender features 702 and the potential recommended social media account features 703 and represents an affinity between a recommender profile and a potential recommended social media account, while the second sub-score is based on the recommendee features 704 and the potential recommended social media account features 703 and represents an affinity between a recommendee profile and the potential recommended social media account.

As yet another example of utilizing heuristic models as part of the recommendation engine 706, the recommendation engine 706 utilizes a heuristic approach to determine a score based on a weighted combination (e.g., a weighted sum or a linear combination) of a first sub-score and a second sub-score, where the recommendation engine 706 applies a weight to the first sub-score and/or the second sub-score. Indeed, the recommendation engine 706 applies a weight based on an indication or determination of a sub-score (e.g., the first sub-score or the second sub-score) that is more impactful to the determination of the overall score. In some embodiments, the first sub-score is based on the recommender features 702 and the potential recommended social media account features 703 and represents an affinity between a recommender profile and a potential recommended social media account, while the second sub-score is based on the recommendee features 704 and the potential recommended social media account features 703 and represents an affinity between a recommendee profile and the potential recommended social media account.

In some embodiments, the recommendation engine 706 includes one or more machine learning models such as neural networks (e.g., a sparse neural network and/or a gradient boosted decision tree) to generate predictions based on the recommender features 702 and the recommendee features 704. Indeed, the recommendation engine 706 generates a score for a particular social media account in relation to a particular recommendee profile and a particular recommender profile. For example, the recommendation engine 706 utilizes a machine learning model to generate a score in the form of a label that represents a probability of recommending a particular social media account. To generate the score, the recommendation engine 706 analyzes a number of features such as the recommender features 702, the potential recommended social media account features 703, and/or the recommendee features 704, as described above. In some embodiments, the recommendation engine 706 generates the score further based on one or more sub-scores that represent an affinity between a recommender profile and a potential recommended social media account and/or an affinity between a recommendee profile and the potential recommended social media account, as described above.

In these or other embodiments, the peer-to-peer recommendation system 102 trains the recommendation engine 706 to generate accurate predictions of social media accounts by utilizing training data such as training profile features and corresponding ground truth social media accounts. Indeed, the peer-to-peer recommendation system 102 trains the recommendation engine 706 by utilizing a loss function to reduce a measure of loss associated with the recommendation engine 706 based on comparing predicted social media accounts for training profile features with ground truth social media accounts. In addition, the peer-to-peer recommendation system 102 modifies internal weights or other parameters to reduce the measure of loss to improve the accuracy of the recommendation engine 706. Further, the peer-to-peer recommendation system 102 can repeat the training process of inputting training profile features, generating predicted social media accounts, comparing with ground truth social media accounts (e.g., using a loss function) and back-propagating to modify various weights (e.g., neuron-specific weights) of the recommendation engine 706 until the measure of loss is below a threshold loss.

In some embodiments, the recommendation engine 706 outputs scores for social media accounts, whereupon the peer-to-peer recommendation system 102 generates a ranked list of social media accounts 708 based on the scores. In other embodiments, the recommendation engine 706 outputs a ranked list of social media accounts 708 based on the respective scores of social media accounts. In addition, the peer-to-peer recommendation system 102 selects a number (e.g., a number equal to the threshold number that the recommender is allowed to recommend to the recommendee) of top-ranked social media accounts 708 to provide to the recommender device 114. In other embodiments, the peer-to-peer recommendation system 102 selects a number of social media accounts 708 that is greater than the number of social media accounts that the recommender is allowed to recommend (so that the recommender can select which social media accounts to recommend).

In one or more embodiments, the peer-to-peer recommendation system 102 utilizes a recommendation engine 706 that includes a first neural network for analyzing the recommender features 702 and a second neural network for analyzing the recommendee features 704. For example, the first neural network generates feature representations of a first set of predicted social media accounts based on the recommender features 702, and the second neural network generates feature representations of a second set of predicted social media accounts based on the recommendee features 704. In addition, the peer-to-peer recommendation system 102 compares the first set of social media accounts and the second set of social media accounts utilizing, for example, a nearest neighbors algorithm to determine distances between various social media accounts in vector space. In these embodiments, the peer-to-peer recommendation system 102 selects one or more social media accounts to include with the list of social media accounts 708 based on their distances in vector space. For instance, the peer-to-peer recommendation system 102 selects those social media accounts within a threshold distance of each other.

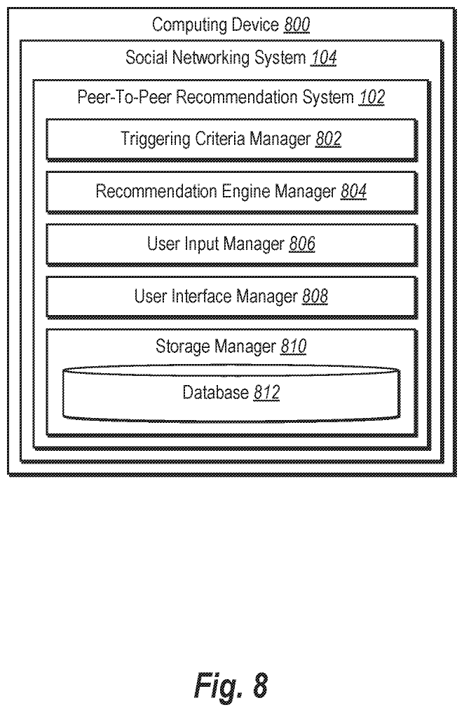

Looking now to FIG. 8, additional detail will be provided regarding components and capabilities of the peer-to-peer recommendation system 102. Specifically, FIG. 8 illustrates an example schematic diagram of the peer-to-peer recommendation system 102 on an example computing device 800 (e.g., one or more of the user devices 108a-108n, the recommender device 114, the recommendee device 112, and/or the server(s) 106). As shown in FIG. 8, the peer-to-peer recommendation system 102 may include a triggering criteria manager 802, a recommendation engine manager 804, a user input manager 806, a user interface manager 808, and a storage manager 810.

As just mentioned, the peer-to-peer recommendation system 102 includes a triggering criteria manager 802. In particular, the triggering criteria manager 802 manages, identifies, determines, detects, monitors, applies, or utilizes triggering criteria for providing social media accounts to a recommender device (e.g., the recommender device 114). For instance, as described above, the triggering criteria manager 802 analyzes recommender features and recommendee features as well as profile activity to determine whether triggering criteria are satisfied to then provide social media accounts to the recommender device and/or to utilize a recommendation engine to generate a list of social media accounts. In some embodiments, the triggering criteria manager 802 communicates with the storage manager 810 to store and/or access triggering criteria within the database 812.

As also mentioned, the peer-to-peer recommendation system 102 includes a recommendation engine manager 804. In particular, the recommendation engine manager 804 manages, utilizes, applies, or implements a recommendation engine to analyze recommender features and recommendee features to generate a plurality of social media accounts. For example, the recommendation engine manager 804 communicates with the triggering criteria manager 802 to determine whether to utilize or refrain from utilizing a recommendation engine (e.g., the recommendation engine 706) to generate a listing of a plurality of social media accounts to provide to a recommender device (e.g., the recommender device 114).

As shown in FIG. 8, the peer-to-peer recommendation system 102 includes a user input manager 806. In particular, the user input manager 806 manages, identifies, determines, receives, monitors, or detects user activity such as user input in relation to various user interface elements such as the selectable options described herein. For example, in some embodiments the user input manager 806 communicates with the storage manager 810 to access one or more activity logs within the database 812 to determine user activity. In addition, the user input manager 806 communicates with the triggering criteria manager 802, the recommendation engine manager 804, and the user interface manager 808 to determine whether triggering criteria are satisfied based on user input, generate social media accounts based on receiving user input, and/or modify a user interface displays on a recommender device (e.g., the recommender device 114) or a recommendee device (e.g., the recommendee device 112).

As also illustrated, the peer-to-peer recommendation system 102 includes a user interface manager 808. In particular, the user interface manager 808 manages, provides, presents, portrays, or displays, or causes to be displayed, various user interface elements on a recommender device (e.g., the recommender device 114) or a recommendee device (e.g., the recommendee device 112). For example, the user interface manager 808 provides notifications, various selectable options, as well as a ranked list of a plurality of social media accounts for a recommender to recommend to a recommendee. In addition, the user interface manager 808 provides notifications and selectable options together with a listing of recommended social media accounts to the recommendee device. The user interface manager 808 can also modify various displayed elements such as lists of social media accounts or notifications based on communicating with the triggering criteria manager 802 to determine changes to recommendee features and/or recommender features.

In one or more embodiments, each of the components of the peer-to-peer recommendation system 102 are in communication with one another using any suitable communication technologies. Additionally, the components of the peer-to-peer recommendation system 102 can be in communication with one or more other devices including one or more user devices described above. It will be recognized that although the components of the peer-to-peer recommendation system 102 are shown to be separate in FIG. 8, any of the subcomponents may be combined into fewer components, such as into a single component, or divided into more components as may serve a particular implementation. Furthermore, although the components of FIG. 8 are described in connection with the peer-to-peer recommendation system 102, at least some of the components for performing operations in conjunction with the peer-to-peer recommendation system 102 described herein may be implemented on other devices within the environment.

The components of the peer-to-peer recommendation system 102 can include software, hardware, or both. For example, the components of the peer-to-peer recommendation system 102 can include one or more instructions stored on a computer-readable storage medium and executable by processors of one or more computing devices (e.g., the computing device 800). When executed by the one or more processors, the computer-executable instructions of the peer-to-peer recommendation system 102 can cause the computing device 800 to perform the methods described herein. Alternatively, the components of the peer-to-peer recommendation system 102 can comprise hardware, such as a special purpose processing device to perform a certain function or group of functions. Additionally or alternatively, the components of the peer-to-peer recommendation system 102 can include a combination of computer-executable instructions and hardware.

Furthermore, the components of the peer-to-peer recommendation system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the peer-to-peer recommendation system 102 may be implemented as part of a stand-alone application on a personal computing device or a mobile device. Alternatively or additionally, the components of the peer-to-peer recommendation system 102 may be implemented in any application that facilitates social networking between users (e.g., an application of the social networking system 104).

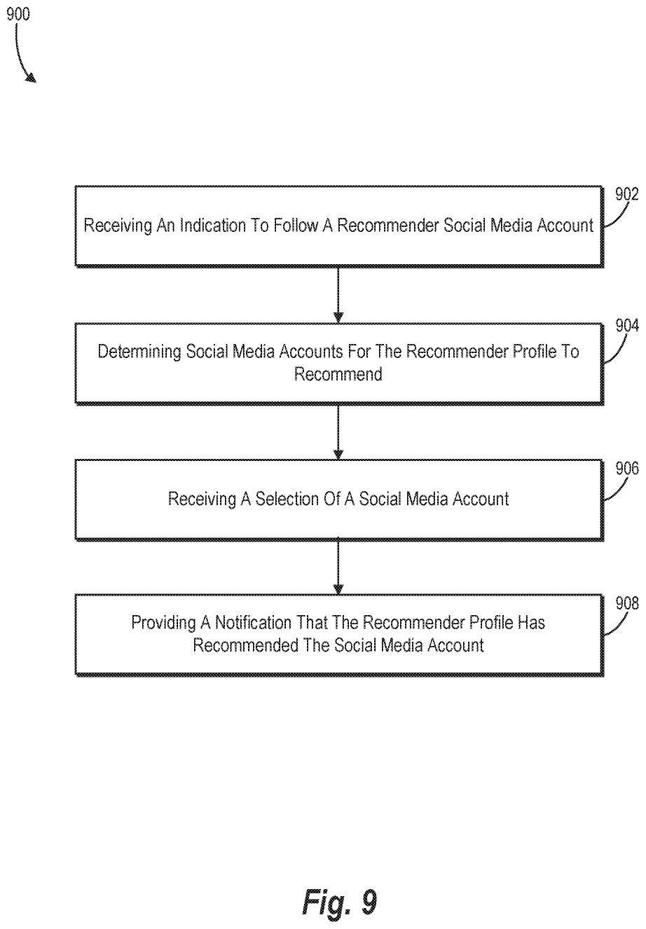

FIGS. 1-8, the corresponding text, and the examples provide a number of different systems, methods, and non-transitory computer readable media for generating and providing a plurality of users for a recommender profile to recommend to a recommendee profile. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates an example series of acts 900 for generating a plurality of users to provide to a recommender profile for recommending to a recommendee profile. The series of acts 900 includes an act 902 of receiving an indication to follow a recommender profile. In particular, the act 902 can include receiving, from a recommendee device associated with a recommendee profile within a social networking system, an indication to follow a recommender profile.

In addition, the series of acts 900 includes an act 904 of determining social media accounts for the recommender profile to recommend. In particular, the act 904 can include determining, by utilizing a recommendation engine based on the indication to follow the recommender profile, a plurality of social media accounts for the recommender profile to recommend to the recommendee profile. For example, the act 904 can involve utilizing the recommendation engine to analyze recommender features, recommendee features, and potential recommended social media account features to generate a ranked list of social media accounts. In addition, the series of acts 900 can include an act of modifying the ranked list of social media accounts. Modifying the ranked list can involve monitoring profile activity of the recommender profile and the recommendee profile and updating one or more of the recommender features, the recommendee features, or the potential recommended social media account features based on the profile activity. The series of acts 900 can also include an act of providing the plurality of social media accounts to the recommender device after an expiration of a threshold period of time.

As shown, the series of acts 900 includes an act 906 of receiving a selection of a social media account. In particular, the act 906 can include receiving, from a recommender device associated with the recommender profile, a selection of a user profile from the plurality of social media accounts to recommend to the recommendee profile.

As further illustrated in FIG. 9, the series of acts 900 can include an act 908 of providing a notification that the recommender profile has recommended the social media account. In particular, the act 908 can include providing, to the recommendee device, a notification that the recommender profile has recommended the social media account for the recommendee profile to follow. The act 908 can involve providing the notification that the recommender profile has recommended the social media account for the recommendee to follow by providing the notification for display within an activity feed of the recommendee profile. In some embodiments, the series of acts 900 can include an act of preventing the recommender profile from recommending more than a threshold number of social media accounts to the recommendee.

The series of acts 900 can further include an act of preventing the recommender profile from spamming the recommendee profile. Preventing the recommender profile from spamming the recommendee profile can include determining triggering criteria. For example, preventing the recommender profile from spamming the recommender profile can include determining that the recommendee profile is a follower of the recommender profile. Preventing the recommender profile from spamming the recommender profile can further involve providing, for display within a recommender user interface presented on the recommender device, a listing of the plurality of social media accounts for the recommender profile to recommend to the recommendee profile based on one or more of: determining that the recommender profile visits the recommendee profile, or determining that the recommender profile follows the recommendee profile after the recommendee profile follows the recommender profile.

Determining triggering criteria to trigger utilizing the recommendation engine to determine the plurality of social media accounts for the recommender profile to recommend can include determining that the recommendee profile comprises a newly registered social media account within the social networking system that has been registered within a threshold recency and that has followed fewer than a threshold number of other u social media accounts. Determining the triggering criteria can further involve determining that the recommender profile has been active for a threshold number of days within a previous time duration and has fewer than a threshold number of followers. Determining the triggering criteria can also (or alternatively) involve determining that the recommender profile has been active for a threshold number of days within a previous time duration and has fewer than a threshold number of followers. Additionally (or alternatively), determining triggering criteria can involve determining that the recommendee profile comprises a newly registered social media account within the social networking system that has been registered within a threshold recency and that has followed fewer than a threshold number of other social media accounts.

The series of acts 900 can include an act of providing, for display within a recommender user interface presented on the recommender device, a listing of the plurality of social media accounts together with a search option whereby a recommender associated with the recommender profile can enter a search query to search for social media accounts to recommend. In addition, the series of acts can include an act of, based on a received search query, searching for social media accounts to identify an additional social media account for the recommender to recommend. The series of acts 900 can also include an act of modifying the notification provided to the recommendee device to indicate the additional social media account.

In addition, the series of acts 900 can include an act of receiving, from the recommendee device, a selection of the notification as well as an act of, in response to the selection of the notification, providing, for display within a recommendee user interface presented on the recommendee device, a selectable option to follow the social media account recommended by the recommender profile.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that may be configured to perform one or more of the processes described above. One will appreciate that one or more computing devices such as the computing device 1000 may implement the peer-to-peer recommendation system 102. As shown by FIG. 10, the computing device 1000 can comprise a processor 1002, a memory 1004, a storage device 1006, an I/O interface 1008, and a communication interface 1010, which may be communicatively coupled by way of a communication infrastructure 1012. While an example computing device 1000 is shown in FIG. 10, the components illustrated in FIG. 10 are not intended to be limiting. Additional or alternative components may be used in other embodiments. Furthermore, in certain embodiments, the computing device 1000 can include fewer components than those shown in FIG. 10. Components of the computing device 1000 shown in FIG. 10 will now be described in additional detail.

In one or more embodiments, the processor 1002 includes hardware for executing instructions, such as those making up a computer program. For example, to execute instructions, the processor 1002 may retrieve (or fetch) the instructions from an internal register, an internal cache, the memory 1004, or the storage device 1006 and decode and execute them. In one or more embodiments, the processor 1002 may include one or more internal caches for data, instructions, or addresses. For example, the processor 1002 may include one or more instruction caches, one or more data caches, and one or more translation lookaside buffers (TLBs). Instructions in the instruction caches may be copies of instructions in the memory 1004 or the storage device 1006.

The memory 1004 may be used for storing data, metadata, and programs for execution by the processor(s). The memory 1004 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1004 may be internal or distributed memory.

The storage device 1006 includes storage for storing data or instructions. For example, storage device 1006 can comprise a non-transitory storage medium described above. The storage device 1006 may include a hard disk drive (HDD), a floppy disk drive, flash memory, an optical disc, a magneto-optical disc, magnetic tape, or a Universal Serial Bus (USB) drive or a combination of two or more of these. The storage device 1006 may include removable or non-removable (or fixed) media, where appropriate. The storage device 1006 may be internal or external to the computing device 1000. In one or more embodiments, the storage device 1006 is non-volatile, solid-state memory. In other embodiments, the storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 1008 allows a user to provide input to, receive output from, and otherwise transfer data to and receive data from computing device 1000. The I/O interface 1008 may include a mouse, a keypad or a keyboard, a touch screen, a camera, an optical scanner, network interface, modem, another known I/O devices or a combination of such I/O interfaces. The I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1008 is configured to provide graphical data to a display for presentation to a user. The graphical data may be representative of one or more graphical user interfaces and/or any other graphical content as may serve a particular implementation.

The communication interface 1010 can include hardware, software, or both. In any event, the communication interface 1010 can provide one or more interfaces for communication (e.g., packet-based communication) between the computing device 1000 and one or more other computing devices or networks. For example, the communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 1010 may facilitate communications with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination thereof.

Additionally, the communication interface 1010 may facilitate communications across various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MIMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1012 may include hardware, software, or both that connects components of the computing device 1000 to each other. For example, the communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the peer-to-peer recommendation system 102 can operate as a social networking system in various embodiments. In addition to the description given above, a social networking system may enable its users (such as persons or organizations) to interact with the system and with each other. The social networking system may, with input from a user, create and store in the social networking system a social media account associated with the user. The social media account may include demographic information, communication-channel information, and information on personal interests of the user. The social networking system may also, with input from a user, create and store a record of relationships of the user with other users of the social networking system, as well as provide services (e.g. wall posts, photo-sharing, online calendars and event organization, messaging, games, or advertisements) to facilitate social interaction between or among users.

Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings.

FIG. 11 illustrates an example network environment 1100 of a networking system. The network environment 1100 includes a networking system 1102 (e.g., the social networking system 104), a user device 1106, and a third-party system 1108 connected to each other by a network 1104. Although FIG. 11 illustrates a particular arrangement of the networking system 1102, the user device 1106, the third-party system 1108, and the network 1104, this disclosure contemplates any suitable arrangement of the devices, systems, and networks. For example, the user device 1106 and the networking system 1102 may be physically or logically co-located with each other in whole, or in part. Moreover, although FIG. 11 illustrates a single user device 1106, the networking system 1102, the third-party system 1108, and the network 1104, this disclosure contemplates any suitable number of devices, systems, and networks.

This disclosure contemplates any suitable network. For example, one or more portions of the network 1104 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1104 may include one or more networks.

Links may connect the networking system 1102, the user device 1106, and the third-party system 1108 to the network 1104 or to each other. In particular embodiments, one or more links include one or more wireline (e.g., Digital Subscriber Line (DSL) or Data Over Cable Service Interface Specification (DOCSIS)), wireless (e.g., Wi-Fi or Worldwide Interoperability for Microwave Access (WiMAX)), or optical (e.g., Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1100. One or more first links may differ in one or more respects from one or more second links.

In particular embodiments, the user device 1106 may be an electronic device including hardware, software, or embedded logic components or a combination of two or more such components and capable of carrying out the appropriate functionalities implemented or supported by the user device 1106. For example, the user device 1106 may include any of the computing devices discussed above in relation to FIG. 10. The user device 1106 may enable a network user to access the network 1104. The user device 1106 may enable its user to communicate with other users associated with other user devices.

In particular embodiments, the user device 1106 may include a web browser, such as MICROSOFT INTERNET EXPLORER, GOOGLE CHROME, MOZILLA FIREFOX, APPLE SAFARI, and may have one or more add-ons, plug-ins, or other extensions (e.g., toolbars). A user at the user device 1106 may enter a Uniform Resource Locator (URL) or other address directing the web browser to a particular server (such as server, or a server associated with the third-party system 1108), and the web browser may generate a Hypertext Transfer Protocol (HTTP) request and communicate the HTTP request to server. The server may accept the HTTP request and communicate to the user device 1106 one or more Hypertext Markup Language (HTML) files responsive to the HTTP request.

The user device 1106 may render a webpage based on the HTML files from the server for presentation to the user. For example, webpages may render from HTML files, Extensible Hypertext Markup Language (XHTML) files, or Extensible Markup Language (XML) files, according to particular needs. Such pages may also execute scripts such as those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the networking system 1102 may be a network-addressable computing system that can host an online network of users (e.g., a social networking system or an electronic messaging system). In some embodiments, such as the illustrated embodiment, the networking system 1102 implements the peer-to-peer recommendation system 102.

The networking system 1102 may generate, store, receive, and send networking data, such as user-profile data, concept-profile data, graph information (e.g., social-graph information), or other suitable data related to the online network of users. The networking system 1102 may be accessed by the other components of network environment 1100 either directly or via the network 1104. In particular embodiments, the networking system 1102 may include one or more servers. Each server may be a unitary server or a distributed server spanning multiple computers or multiple datacenters. Servers may be of various types, such as web server, news server, mail server, message server, advertising server, file server, application server, exchange server, database server, proxy server, another server suitable for performing functions or processes described herein, or any combination thereof.

In one or more embodiments, each server may include hardware, software, or embedded logic components or a combination of two or more such components for carrying out the appropriate functionalities implemented or supported by a server. In particular embodiments, the networking system 1102 may include one or more data stores. Data stores may be used to store various types of information. In particular embodiments, the information stored in data stores may be organized according to specific data structures. In particular embodiments, each data store may be a relational, columnar, correlation, or another suitable database. Although this disclosure describes or illustrates particular types of databases, this disclosure contemplates any suitable types of databases. Particular embodiments may provide interfaces that enable the networking system 1102, the user device 1106, or the third-party system 1108 to manage, retrieve, modify, add, or delete, the information stored in a data store.

In particular embodiments, the networking system 1102 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. The networking system 1102 may provide users of the online network of users the ability to communicate and interact with other users. In particular embodiments, users may join the online network of users via the networking system 1102 and then add connections (e.g., relationships) to a number of other users of the networking system 1102 whom they want to be connected to. Herein, the term “friend” may refer to any other user of the networking system 1102 with whom a user has formed a connection, association, or relationship via the networking system 1102.

In particular embodiments, the networking system 1102 may provide users with the ability to take actions on various types of items or objects, supported by the networking system 1102. For example, the items and objects may include groups or social networks to which users of the networking system 1102 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the networking system 1102 or by an external system of the third-party system 1108, which is separate from the networking system 1102 and coupled to the networking system 1102 via the network 1104.

In particular embodiments, the networking system 1102 may be capable of linking a variety of entities. For example, the networking system 1102 may enable users to interact with each other as well as receive content from the third-party systems 1108 or other entities, or to allow users to interact with these entities through an application programming interfaces (API) or other communication channels.

In particular embodiments, the third-party system 1108 may include one or more types of servers, one or more data stores, one or more interfaces, including but not limited to APIs, one or more web services, one or more content sources, one or more networks, or any other suitable components, e.g., that servers may communicate with. The third-party system 1108 may be operated by a different entity from an entity operating the networking system 1102. In particular embodiments, however, the networking system 1102 and the third-party systems 1108 may operate in conjunction with each other to provide social networking services to users of the networking system 1102 or the third-party systems 1108. In this sense, the networking system 1102 may provide a platform, or backbone, which other systems, such as the third-party systems 1108, may use to provide social networking services and functionality to users across the Internet.

In particular embodiments, the third-party system 1108 may include a third-party content object provider. A third-party content object provider may include one or more sources of content objects, which may be communicated to a user device 1106. For example, content objects may include information regarding things or activities of interest to the user, such as movie showtimes, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the networking system 1102 also includes user-generated content objects, which may enhance a user's interactions with the networking system 1102. User-generated content may include anything a user can add, upload, send, or “post” to the networking system 1102. For example, a user communicates posts to the networking system 1102 from a user device 1106. Posts may include data such as status updates or other textual data, location information, photos, videos, links, music or other similar data or media. Content may also be added to the networking system 1102 by a third-party through a “communication channel,” such as a newsfeed or stream.

In particular embodiments, the networking system 1102 may include a variety of servers, sub-systems, programs, modules, logs, and data stores. In particular embodiments, the networking system 1102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The networking system 1102 may also include suitable components such as network interfaces, security mechanisms, load balancers, failover servers, management-and-network-operations consoles, other suitable components, or any suitable combination thereof. In particular embodiments, the networking system 1102 may include one or more user-profile stores for storing social media accounts.

A social media account may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. For example, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes.

The connection information may also include user-defined connections between different users and content (both internal and external). A web server may be used for linking the networking system 1102 to one or more user device 1106 or one or more the third-party system 1108 via the network 1104. The web server may include a mail server or other messaging functionality for receiving and routing messages between the networking system 1102 and one or more user device 1106. An API-request server may allow the third-party system 1108 to access information from the networking system 1102 by calling one or more APIs. An action logger may be used to receive communications from a web server about a user's actions on or off networking system 1102. In conjunction with the action log, a third-party-content-object log may be maintained of user exposures to third-party-content objects. A notification controller may provide information regarding content objects to a user device 1106.

Information may be pushed to a user device 1106 as notifications, or information may be pulled from user device 1106 responsive to a request received from user device 1106. Authorization servers may be used to enforce one or more privacy settings of the users of the networking system 1102. A privacy setting of a user determines how particular information associated with a user can be shared. The authorization server may allow users to opt in to or opt out of having their actions logged by the networking system 1102 or shared with other systems (e.g., the third-party system 1108), such as by setting appropriate privacy settings. Third-party-content-object stores may be used to store content objects received from third parties, such as the third-party system 1108. Location stores may be used for storing location information received from user device 1106 associated with users. Advertisement-pricing modules may combine social information, the current time, location information, or other suitable information to provide relevant advertisements, in the form of notifications, to a user.

FIG. 12 illustrates example social graph 1200. In particular embodiments, the networking system 1102 may store one or more social graphs 1200 in one or more data stores. In particular embodiments, social graph 1200 may include multiple nodes—which may include multiple user nodes 1202 or multiple concept nodes 1204—and multiple edges 1206 connecting the nodes. Example social graph 1200 illustrated in FIG. 12 is shown, for didactic purposes, in a two-dimensional visual map representation. In particular embodiments, the networking system 1102, the user device 1106, or the third-party system 1108 may access social graph 1200 and related social-graph information for suitable applications. The nodes and edges of social graph 1200 may be stored as data objects, for example, in a data store (such as a social-graph database). Such a data store may include one or more searchable or quarriable indexes of nodes or edges of social graph 1200.

In particular embodiments, a user node 1202 may correspond to a user of the networking system 1102. For example, a user may be an individual (human user), an entity (e.g., an enterprise, business, or third-party application), or a group (e.g., of individuals or entities) that interacts or communicates with or over networking system 1102. In particular embodiments, when a user registers for an account with the networking system 1102, the networking system 1102 may create a user node 1202 corresponding to the user and store the user node 1202 in one or more data stores. Users and user nodes 1202 described herein may, where appropriate, refer to registered users and user nodes 1202 associated with registered users.

In addition, or as an alternative, users and user nodes 1202 described herein may, where appropriate, refer to users that have not registered with the networking system 1102. In particular embodiments, a user node 1202 may be associated with information provided by a user or information gathered by various systems, including the networking system 1102. For example, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 1204 may correspond to a concept. For example, a concept may correspond to a place (e.g., a movie theater, restaurant, landmark, or city); a website (e.g., a website associated with network system 1102 or a third-party website associated with a web-application server); an entity (e.g., a person, business, group, sports team, or celebrity); a resource (e.g., an audio file, video file, digital photo, text file, structured document, or application) which may be located within the networking system 1102 or on an external server, such as a web-application server; real or intellectual property (e.g., a sculpture, painting, movie, game, song, idea, photograph, or written work); a game; an activity; an idea or theory; another suitable concept; or two or more such concepts. A concept node 1204 may be associated with information of a concept provided by a user or information gathered by various systems, including the networking system 1102. For example, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1204 may be associated with one or more data objects corresponding to information associated with concept node 1204. In particular embodiments, a concept node 1204 may correspond to one or more webpages.

In particular embodiments, a node in the social graph 1200 may represent or be represented by a webpage (which may be referred to as a “profile page”). Profile pages may be hosted by or accessible to the networking system 1102. Profile pages may also be hosted on third-party websites associated with a third-party system 1108. For example, a profile page corresponding to a particular external webpage may be the particular external webpage, and the profile page may correspond to a particular concept node 1204. Profile pages may be viewable by all or a selected subset of other users. For example, a user node 1202 may have a corresponding user-profile page in which the corresponding user may add content, make declarations, or otherwise express himself or herself. As another example and not by way of limitation, a concept node 1204 may have a corresponding concept-profile page in which one or more users may add content, make declarations, or express themselves, particularly in relation to the concept corresponding to concept node 1204.

In particular embodiments, a concept node 1204 may represent a third-party webpage or resource hosted by the third-party system 1108. The third-party webpage or resource may include, among other elements, content, a selectable or another icon, or another inter-actable object (which may be implemented, for example, in JavaScript, AJAX, or PHP codes) representing an action or activity. For example, a third-party webpage may include a selectable icon such as “like,” “check-in,” “eat,” “recommend,” or another suitable action or activity. A user viewing the third-party webpage may perform an action by selecting one of the icons (e.g., “eat”), causing a user device 1106 to send to the networking system 1102 a message indicating the user's action. In response to the message, the networking system 1102 may create an edge (e.g., an “eat” edge) between a user node 1202 corresponding to the user and a concept node 1204 corresponding to the third-party webpage or resource and store edge 1206 in one or more data stores.

In particular embodiments, a pair of nodes in the social graph 1200 may be connected to each other by one or more edges 1206. An edge 1206 connecting a pair of nodes may represent a relationship between the pair of nodes. In particular embodiments, an edge 1206 may include or represent one or more data objects or attributes corresponding to the relationship between a pair of nodes. For example, a first user may indicate that a second user is a “friend” of the first user. In response to this indication, the networking system 1102 may send a “friend request” to the second user.

If the second user confirms the “friend request,” networking system 1102 may create an edge 1206 connecting the first user's user node 1202 to the second user's user node 1202 in the social graph 1200 and store edge 1206 as social-graph information in one or more of data stores. In the example of FIG. 12, social graph 1200 includes an edge 1206 indicating a friend relation between user nodes 1202 of user “A” and user “B” and an edge indicating a friend relation between user nodes 1202 of user “C” and user “B.” Although this disclosure describes or illustrates particular edges 1206 with particular attributes connecting particular user nodes 1202, this disclosure contemplates any suitable edges 1206 with any suitable attributes connecting user nodes 1202. For example, an edge 1206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 1200 by one or more edges 1206.

In particular embodiments, an edge 1206 between a user node 1202 and a concept node 1204 may represent a particular action or activity performed by a user associated with user node 1202 toward a concept associated with a concept node 1204. For example, as illustrated in FIG. 12, a user may “like,” “attended,” “played,” “listened,” “cooked,” “worked at,” or “watched” a concept, each of which may correspond to an edge type or subtype. A concept-profile page corresponding to a concept node 1204 may include, for example, a selectable “check-in” icon (e.g., a clickable “check-in” icon) or a selectable “add to favorites” icon. Similarly, after a user clicks these icons, the networking system 1102 may create a “favorite” edge or a “check-in” edge in response to a user's action corresponding to a respective action.

As another example and not by way of limitation, a user (user “C”) may listen to a particular song (“Ramble On”) using a particular application (SPOTIFY, which is an online music application). In this case, the networking system 1102 may create a “listened” edge 1206 and a “used” edge (as illustrated in FIG. 12) between user nodes 1202 corresponding to the user and concept nodes 1204 corresponding to the song and application to indicate that the user listened to the song and used the application.

Moreover, the networking system 1102 may create a “played” edge 1206 (as illustrated in FIG. 12) between concept nodes 1204 corresponding to the song and the application to indicate that the particular song was played by the particular application. In this case, “played” edge 1206 corresponds to an action performed by an external application (SPOTIFY) on an external audio file (the song “Imagine”). Although this disclosure describes particular edges 1206 with particular attributes connecting user nodes 1202 and concept nodes 1204, this disclosure contemplates any suitable edges 1206 with any suitable attributes connecting user nodes 1202 and concept nodes 1204.

Furthermore, although this disclosure describes edges between a user node 1202 and a concept node 1204 representing a single relationship, this disclosure contemplates edges between a user node 1202 and a concept node 1204 representing one or more relationships. For example, an edge 1206 may represent both that a user likes and has used at a particular concept. Alternatively, another edge 1206 may represent each type of relationship (or multiples of a single relationship) between a user node 1202 and a concept node 1204 (as illustrated in FIG. 12 between user node 1202 for user “E” and concept node 1204 for “SPOTIFY”).

In particular embodiments, the networking system 1102 may create an edge 1206 between a user node 1202 and a concept node 1204 in the social graph 1200. For example, a user viewing a concept-profile page (e.g., by using a web browser or a special-purpose application hosted by the user's user device 1106) may indicate that he or she likes the concept represented by the concept node 1204 by clicking or selecting a “Like” icon, which may cause the user's user device 1106 to send to the networking system 1102 a message indicating the user's liking of the concept associated with the concept-profile page.

In response to the message, the networking system 1102 may create an edge 1206 between user node 1202 associated with the user and concept node 1204, as illustrated by “like” edge 1206 between the user and concept node 1204. In particular embodiments, the networking system 1102 may store an edge 1206 in one or more data stores. In particular embodiments, an edge 1206 may be automatically formed by the networking system 1102 in response to a particular user action. For example, if a first user uploads a picture, watches a movie, or listens to a song, an edge 1206 may be formed between user node 1202 corresponding to the first user and concept nodes 1204 corresponding to those concepts. Although this disclosure describes forming particular edges 1206 in particular manners, this disclosure contemplates forming any suitable edges 1206 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on the networking system 1102)

A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a predetermined area of a profile page of a user or other page, presented with additional information associated with the advertiser, bumped up or otherwise highlighted within news feeds or tickers of other users, or otherwise promoted. The advertiser may pay to have the social action promoted. For example, advertisements may be included among the search results of a search-results page, where sponsored content is promoted over non-sponsored content.

In particular embodiments, an advertisement may be requested for display within social networking system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. For example, the user may view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, the networking system 1102 may execute or modify a particular action of the user.

An advertisement may also include social networking-system functionality that a user may interact with. For example, an advertisement may enable a user to “like” or otherwise endorse the advertisement by selecting an icon or link associated with the endorsement. As another example and not by way of limitation, an advertisement may enable a user to search (e.g., by executing a query) for content related to the advertiser. Similarly, a user may share the advertisement with another user (e.g., through the networking system 1102) or RSVP (e.g., through the networking system 1102) to an event associated with the advertisement. In addition, or as an alternative, an advertisement may include a social networking system context directed to the user. For example, an advertisement may display information about a friend of the user within the networking system 1102 who has taken an action associated with the subject matter of the advertisement.

In particular embodiments, the networking system 1102 may determine the social-graph affinity (which may be referred to herein as “affinity”) of various social-graph entities for each other. Affinity may represent the strength of a relationship or level of interest between particular objects associated with the online network of users, such as users, concepts, content, actions, advertisements, other objects associated with the online network of users, or any suitable combination thereof. Affinity may also be determined with respect to objects associated with the third-party systems 1108 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the networking system 1102 may measure or quantify social-graph affinity using an affinity coefficient (which may be referred to herein as “coefficient”). The coefficient may represent or quantify the strength of a relationship between particular objects associated with the online network of users. The coefficient may also represent a probability or function that measures a predicted probability that a user will perform a particular action based on the user's interest in the action. In this way, a user's future actions may be predicted based on the user's prior actions, where the coefficient may be calculated at least in part based on the history of the user's actions. Coefficients may be used to predict any number of actions, which may be within or outside of the online network of users. For example, these actions may include various types of communications, such as sending messages, posting content, or commenting on content; various types of an observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the networking system 1102 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static, or the weights may change according to, for example, the user, the type of relationship, the type of action, the user's location, and so forth. Ratings for the factors may be combined according to their weights to determine an overall coefficient for the user. For example, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the networking system 1102 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. For example, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the networking system 1102 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the networking system 1102 may calculate a coefficient based on a user's actions. The networking system 1102 may monitor such actions on the online network of users, on the third-party system 1108, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, the networking system 1102 may calculate a coefficient based on the user's actions with particular types of content. The content may be associated with the online network of users, the third-party system 1108, or another suitable system. The content may include users, profile pages, posts, news stories, headlines, instant messages, chat room conversations, email s, advertisements, pictures, video, music, other suitable objects, or any combination thereof. The networking system 1102 may analyze a user's actions to determine whether one or more of the actions indicate an affinity for the subject matter, content, other users, and so forth. For example, if a user may make frequently posts content related to “coffee” or variants thereof, the networking system 1102 may determine the user has a high coefficient with respect to the concept “coffee.” Particular actions or types of actions may be assigned a higher weight and/or rating than other actions, which may affect the overall calculated coefficient. For example, if a first user emails a second user, the weight or the rating for the action may be higher than if the first user views the user-profile page for the second user.

In particular embodiments, the networking system 1102 may calculate a coefficient based on the type of relationship between particular objects. Referencing the social graph 1200, the networking system 1102 may analyze the number and/or type of edges 1206 connecting particular user nodes 1202 and concept nodes 1204 when calculating a coefficient. For example, user nodes 1202 that are connected by a spouse-type edge (representing that the two users are married) may be assigned a higher coefficient than a user nodes 1202 that are connected by a friend-type edge. In other words, depending upon the weights assigned to the actions and relationships for the particular user, the overall affinity may be determined to be higher for content about the user's spouse than for content about the user's friend.

In particular embodiments, the relationships a user has with another object may affect the weights and/or the ratings of the user's actions with respect to calculating the coefficient for that object. For example, if a user is tagged in a first photo, but merely likes a second photo, the networking system 1102 may determine that the user has a higher coefficient with respect to the first photo than the second photo because having a tagged-in-type relationship with content may be assigned a higher weight and/or rating than having a like-type relationship with content.

In some embodiments, the networking system 1102 may calculate a coefficient for a first user based on the relationship one or more second users have with a particular object. In other words, the connections and coefficients other users have with an object may affect the first user's coefficient for the object. For example, if a first user is connected to or has a high coefficient for one or more second users, and those second users are connected to or have a high coefficient for a particular object, the networking system 1102 may determine that the first user should also have a relatively high coefficient for the particular object.

In one or more embodiments, the coefficient may be based on the degree of separation between particular objects. The degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.”

Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 1200. For example, social-graph entities that are closer in the social graph 1200 (i.e., fewer degrees of separation) may have a higher coefficient than entities that are further apart in the social graph 1200.

In particular embodiments, the networking system 1102 may calculate a coefficient based on location information. Objects that are geographically closer to each other may be considered to be more related, or of more interest, to each other than more distant objects. In some embodiments, the coefficient of a user towards a particular object may be based on the proximity of the object's location to a current location associated with the user (or the location of a user device 1106 of the user). A first user may be more interested in other users or concepts that are closer to the first user. For example, if a user is one mile from an airport and two miles from a gas station, the networking system 1102 may determine that the user has a higher coefficient for the airport than the gas station based on the proximity of the airport to the user.

In particular embodiments, the networking system 1102 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the networking system 1102 may provide information that is relevant to a user's interests and current circumstances, increasing the likelihood that they will find such information of interest.

In some embodiments, the networking system 1102 may generate content based on coefficient information. Content objects may be provided or selected based on coefficients specific to a user. For example, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object.

In one or more embodiments, the networking system 1102 may generate search results based on coefficient information. The search results for a particular user may be scored or ranked based on the coefficient associated with the search results with respect to the querying user. For example, search results corresponding to objects with higher coefficients may be ranked higher on a search-results page than results corresponding to objects having lower coefficients.

In particular embodiments, the networking system 1102 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online network of users, from the third-party system 1108 (e.g., via an API or another communication channel), or from another suitable system. In response to the request, the networking system 1102 may calculate the coefficient (or access the coefficient information if it has previously been calculated and stored).

In various embodiments, the networking system 1102 may measure an affinity with respect to a particular process. Different processes (both internal and external to the online network of users) may request a coefficient for a particular object or set of objects. The networking system 1102 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed Aug. 11, 2006, U.S. patent application Ser. No. 12/977,027, filed Dec. 22, 2010, U.S. patent application Ser. No. 12/978265, filed Dec. 23, 2010, and U.S. patent application Ser. No. 13/632869, filed Oct. 01, 2012, each of which is incorporated by reference in their entirety.

In particular embodiments, one or more of the content objects of the online network of users may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online network of users. Where the privacy settings for an object allow a particular user to access that object, the object may be described as being “visible” with respect to that user. For example, a user of the online network of users may specify privacy settings for a user-profile page identify a set of users that may access the work experience information on the user-profile page, thus excluding other users from accessing the information.

In particular embodiments, the privacy settings may specify a “blocked list” of users that should not be allowed to access certain information associated with the object. In other words, the blocked list may specify one or more users or entities for which an object is not visible. For example, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online network of users. For example, a particular concept node 1204 corresponding to a particular photo may have a privacy setting specifying that the photo may only be accessed by users tagged in the photo and their friends.

In particular embodiments, privacy settings may allow users to opt in or opt out of having their actions logged by the networking system 1102 or shared with other systems (e.g., the third-party system 1108). In particular embodiments, the privacy settings associated with an object may specify any suitable granularity of permitted access or denial of access. For example, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of the third-party systems 1108, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, the networking system 1102 may send a request to the data store for the object. The request may identify the user associated with the request and may only be sent to the user (or a user device 1106 of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user.

In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a recommendee device associated with a recommendee profile within a social networking system, an indication to follow a recommender profile;
determining, by utilizing a recommendation engine based on the indication to follow the recommender profile, a plurality of social media accounts for the recommender profile to recommend to the recommendee profile;
receiving, from a recommender device associated with the recommender profile, a selection of a social media account from the plurality of social media accounts to recommend to the recommendee profile; and
providing, to the recommendee device, a notification that the recommender profile has recommended the social media account for the recommendee profile to follow.

2. The method of claim 1, wherein determining the plurality of social media accounts for the recommender profile to recommend to the recommendee profile comprises utilizing the recommendation engine to analyze recommender features, recommendee features, and potential recommended social media account features to generate a ranked list of social media accounts.

3. The method of claim 1, further comprising preventing the recommender profile from spamming the recommendee profile by:
determining that the recommendee profile is a follower of the recommender profile; and
providing, for display within a recommender user interface presented on the recommender device, a listing of the plurality of social media accounts for the recommender profile to recommend to the recommendee profile based on one or more of:
determining that the recommender profile visits the recommendee profile; or
determining that the recommender profile follows the recommendee profile after the recommendee profile follows the recommender profile.

4. The method of claim 1, further comprising determining triggering criteria to trigger utilizing the recommendation engine to determine the plurality of social media accounts for the recommender profile to recommend, wherein determining the triggering criteria comprises determining that the recommendee profile comprises a newly registered social media account within the social networking system that has been registered within a threshold recency and that has followed fewer than a threshold number of other social media accounts.

5. The method of claim 4, wherein determining the triggering criteria further comprises determining that the recommender profile has been active for a threshold number of days within a previous time duration and has fewer than a threshold number of followers.

6. The method of claim 1, further comprising:
providing, for display within a recommender user interface presented on the recommender device, a listing of the plurality of users together with a search option whereby a recommender associated with the recommender profile can enter a search query to search for social media accounts to recommend;
based on a received search query, searching for social media accounts to identify an additional social media account for the recommender to recommend; and
modifying the notification provided to the recommendee device to indicate the additional social media account.

7. The method of claim 1, further comprising:
receiving, from the recommendee device, a selection of the notification; and
in response to the selection of the notification, providing, for display within a recommendee user interface presented on the recommendee device, a selectable option to follow the social media account recommended by the recommender profile.

8. A system comprising:
at least one processor; and
a non-transitory computer readable medium comprising instructions that, when executed by the at least one processor, cause the system to:
receive, from a recommendee device associated with a recommendee profile within a social networking system, an indication to follow a recommender profile;
determine, by utilizing a recommendation engine based on the indication to follow the recommender profile, a plurality of social media accounts for the recommender profile to recommend to the recommendee profile;
receive, from a recommender device associated with the recommender profile, a selection of a social media account from the plurality of social media accounts to recommend to the recommendee profile; and
provide, to the recommendee device, a notification that the recommender profile has recommended the social media account for the recommendee profile to follow.

9. The system of claim 8, further comprising instructions that, when executed by the at least one processor, cause the system to determine the plurality of social media accounts for the recommender profile to recommend to the recommendee profile by utilizing the recommendation engine to analyze recommender features, recommendee features, and potential recommended social media account features to generate a ranked list of social media accounts.

10. The system of claim 9, further comprising instructions that, when executed by the at least one processor, cause the system to dynamically modify the ranked list of social media accounts by:
monitoring profile activity of the recommender profile and the recommendee profile; and
updating one or more of the recommender features, the recommendee features, or the potential recommended social media account features based on the profile activity.

11. The system of claim 8, further comprising instructions that, when executed by the at least one processor, cause the system to prevent the recommender profile from recommending more than a threshold number of social media accounts to the recommendee.

12. The system of claim 8, further instructions that, when executed by the at least one processor, cause the system to determine triggering criteria to trigger utilizing the recommendation engine to determine the plurality of social media accounts for the recommender profile to recommend by determining that the recommendee is a follower of the recommender.

13. The system of claim 12, further comprising instructions that, when executed by the at least one processor, cause the system to determine the triggering criteria by further determining one or more of: the recommender profile visiting the recommendee profile or the recommender profile following the recommendee profile after the recommendee profile follows the recommender profile.

14. The system of claim 13, further comprising instructions that, when executed by the at least one processor, cause the system to provide the plurality of social media accounts to the recommender device after an expiration of a threshold period of time.

15. A non-transitory computer readable medium comprising instructions that, when executed by at least one processor, cause a computer device to:
receive, from a recommendee device associated with a recommendee profile within a social networking system, an indication to follow a recommender profile;
determine, by utilizing a recommendation engine based on the indication to follow the recommender profile, a plurality of social media accounts for the recommender profile to recommend to the recommendee profile;
receive, from a recommender device associated with the recommender profile, a selection of a social media account from the plurality of social media accounts to recommend to the recommendee profile; and
provide, to the recommendee device, a notification that the recommender profile has recommended the social media account for the recommendee profile to follow.

16. The non-transitory computer readable medium of claim 15, further comprising instructions that, when executed by the at least one processor, cause the computer device to provide the notification that the recommender profile has recommended the social media account for the recommendee to follow by providing the notification for display within an activity feed of the recommendee profile.

17. The non-transitory computer readable medium of claim 15, further comprising instructions that, when executed by the at least one processor, cause the computer device to prevent the recommender profile from spamming the recommendee profile by determining triggering criteria that triggers utilizing the recommendation engine to determine the plurality of social media accounts for the recommender profile to recommend.

18. The non-transitory computer readable medium of claim 17, wherein determining the triggering criteria comprises:
determining that the recommendee profile is a follower of the recommender profile; and one or more of:
determining that the recommender profile visits the recommendee profile; or
determining that the recommender profile follows the recommendee profile after the recommendee profile follows the recommender profile.

19. The non-transitory computer readable medium of claim 18, wherein determining the triggering criteria further comprises determining that the recommender profile has been active for a threshold number of days within a previous time duration and has fewer than a threshold number of followers.

20. The non-transitory computer readable medium of claim 19, wherein determining the triggering criteria further comprises determining that the recommendee profile comprises a newly registered social media account within the social networking system that has been registered within a threshold recency and that has followed fewer than a threshold number of other social media accounts.
